(19) United States
(12) Patent Application Publication
(10) Pub. No.: US 2026/0368296 A1
(43) Pub. Date: Nov. 19, 2026

(54) SYSTEMS, METHODS AND PLATFORMS FOR IDENTITY INTELLIGENCE

(71) Applicant: S.E.R.P.E.N.T Industries, Sarasota, FL (US)

(72) Inventors: Michael Casarona, Sarasota, FL (US); Michael McCarty, Orefield, PA (US)

(21) Appl. No.: 19/652,217

(22) Filed: Apr. 20, 2026

Related U.S. Application Data
(60) Provisional application No. 63/791,141, filed on Apr. 18, 2025.

(51) Int. Cl. G06F 21/32; G06F 16/951; G06F 16/9535; G06F 16/955; G06V 40/16

(52) U.S. Cl. CPC G06F 21/32; G06F 16/951; G06F 16/9535; G06F 16/9566; G06V 40/172

(57) ABSTRACT

Provided herein are systems, methods, and platforms for identity intelligence, the system including: at least one processor; and a memory communicatively connected to the at least one processor, wherein the memory contains instructions configuring the at least one processor to: receive, from a user, image data wherein the image data includes an image of a face; receive a user authentication datum; extract a plurality of facial features from the image data; perform a reverse facial lookup; perform an artificial intelligence (AI) image analysis; aggregate the subset of candidate results and the set of estimated demographic characteristics into a results dataset; and output the results dataset to the user.

### CROSS REFERENCE TO RELATED APPLICATIONS

This application claims the benefit of priority to U.S. Provisional Application No. 63/791,141, filed on Apr. 18, 2025, and entitled “AI-POWERED REVERSE IMAGE LOOKUP PLATFORM,” the entirety of which is incorporated herein by reference.

### FIELD OF THE INVENTION

The present invention is directed generally to a method and apparatus for image lookup platforms and, more particularly, to systems, methods and platforms for identity intelligence.

### BACKGROUND OF THE INVENTION

Historically, traditional safety searches show someone's identity through simple searches through basic public data.

However, the traditional searches employed historically fails to provide real-time, reliable verification which evidences a disadvantage in that someone's identification can easily be unverifiable and can lead to online scams, catfishing, and identity theft.

Additionally, traditional tools often require a name, location, age, or other reference data, which can be challenging to obtain or may be unavailable.

Therefore, the need exists for a search system that provides a reliable way to verify someone's identity in real time.

### SUMMARY

In some aspects, the techniques described herein relate to a system for identity intelligence, the system including: at least one processor; and a memory communicatively connected to the at least one processor, wherein the memory contains instructions configuring the at least one processor to: receive, from a user, image data wherein the image data includes an image of a face; receive a user authentication datum; extract a plurality of facial features from the image data; perform a reverse facial lookup, wherein performing the reverse facial lookup includes: inputting the plurality of facial features; and receiving, in response to the plurality of facial features a subset of candidate results ; perform an artificial intelligence (AI) image analysis, wherein the AI image analysis includes: inputting the plurality of facial features into an image analysis model; and receiving as output from the image analysis model, a set of estimated demographic characteristics and an artificial generation likelihood score; aggregate the subset of candidate results and the set of estimated demographic characteristics into a results dataset, wherein aggregating the subset of candidate results and the set of estimated demographic characteristics into the results dataset includes: aggregating the subset of candidate results and the set of estimated demographic characteristics into a common data structure; filtering the results dataset to remove low-confidence data and outliers; and clustering the results dataset into one or more profiles using a clustering algorithm; and output the results dataset to the user.

In some aspects, the techniques described herein relate to a computer-implemented method for identity intelligence, the method including: receiving, from a user and using at least one processor, image data wherein the image data includes an image of a face; receiving, using the at least one processor, a user authentication datum; extracting, using the at least one processor, a plurality of facial features from the image data; performing, using the at least one processor, a reverse facial lookup, wherein performing the reverse facial lookup includes: inputting the plurality of facial features; and receiving, in response to the plurality of facial features a subset of candidate results ; performing, using the at least one processor, an artificial intelligence (AI) image analysis, wherein the AI image analysis includes: inputting the plurality of facial features into an image analysis model; receiving as output from the image analysis model, a set of estimated demographic characteristics and an artificial generation likelihood score; aggregating, using the at least one processor, the subset of candidate results and the set of estimated demographic characteristics into a results dataset, wherein aggregating the subset of candidate results and the set of estimated demographic characteristics into the results dataset includes: aggregating the subset of candidate results and the set of estimated demographic characteristics into a common data structure; filtering the results dataset to remove low-confidence data and outliers; and clustering the results dataset into one or more profiles using a clustering algorithm; and outputting, using the at least one processor, the results dataset to the user.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIGS. 1A-1B show an embodiment of a system for reverse image searching;

FIG. 2 shows a flow diagram of an exemplary embodiment of a passive threat detection process is shown;

FIG. 3 shows a flow diagram of an exemplary embodiment of a reverse name search;

FIG. 4 shows a flow diagram of an exemplary embodiment of a results rollup process;

FIG. 5 shows a flow diagram of a secondary search script;

FIG. 6 shows a flow diagram of a dataset cleaner script;

FIG. 7 shows an exemplary embodiment of a gateway and microservice architecture 700;

FIGS. 8-13D show various user interfaces for the systems, methods and platforms for reverse-image searching;

FIG. 14 shows an exemplary email report;

FIG. 15 shows a flow diagram for an exemplary method for identity intelligence;

FIG. 16 shows an exemplary machine-learning module;

FIG. 17 shows an exemplary neural network; and

FIG. 18 shows a diagrammatic representation of one embodiment of a computing device in the exemplary form of a computer system.

### DETAILED DESCRIPTION

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, the term “ratio” refers to a relationship between two numbers (e.g., scores, summations, and the like). Although, ratios can be expressed in a particular order (e.g., a to b or a:b), one of ordinary skill in the art will recognize that the underlying relationship between the numbers can be expressed in any order without losing the significance of the underlying relationship, although observation and correlation of trends based on the ration may need to be reversed. For example, if the values of a over time are (4, 10) and the values of b over time are (2, 4), the ratio a:b will equal (2, 2.5), while the ratio b:a will be (0.5, 0.4). Although the values of a and b are the same in both ratios, the ratios a:b and b:a are inverse and increase and decrease, respectively, over the time period.

A “display device,” for the purposes of this disclosure is a device that is configured to display information to a user.

An “input device,” for the purposes of this disclosure, is a device that allows a user to interact with a computing device so as to provide input to the computing device.

A “graphical user interface,” for the purposes of this disclosure, is a user interface through which a user may interact using one or more graphical elements.

For the purposes of this disclosure, “cloud storage system” is a cloud-based storage service used to persist and retrieve objects such as images identified by unique keys.

For the purposes of this disclosure, a “confidence score” is a numerical value representing the likelihood or certainty of a given prediction, match, or inference generated by an algorithm or model.

### Detailed Description

Provided herein are systems, methods, and platforms, identity intelligence.

The present disclosure may include a reverse lookup platform that may help users uncover a person's digital footprint using facial recognition and intelligent search algorithms by allowing users to upload a photo. Furthermore, in some embodiments, the present disclosure may utilize artificial intelligence to perform searches throughout different digital footprints.

The present disclosure solves problems experienced with the prior art because it provides a search system that provides a reliable way to verify someone's identity in real time. Additionally, traditional tools often require a name, location, age, or other reference data, which can be challenging to obtain or may be unavailable. This system allows for identity verification using only a picture. Those and other advantages and benefits of the present invention will become apparent from the detailed description of the invention hereinbelow

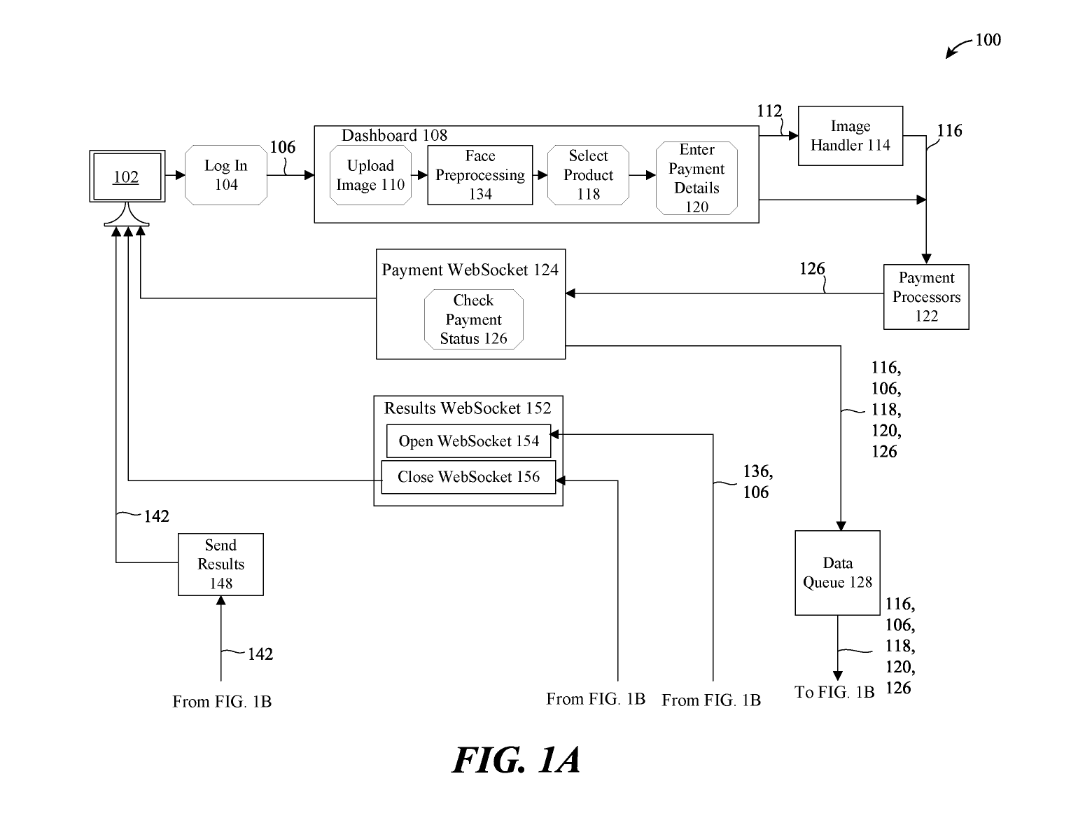

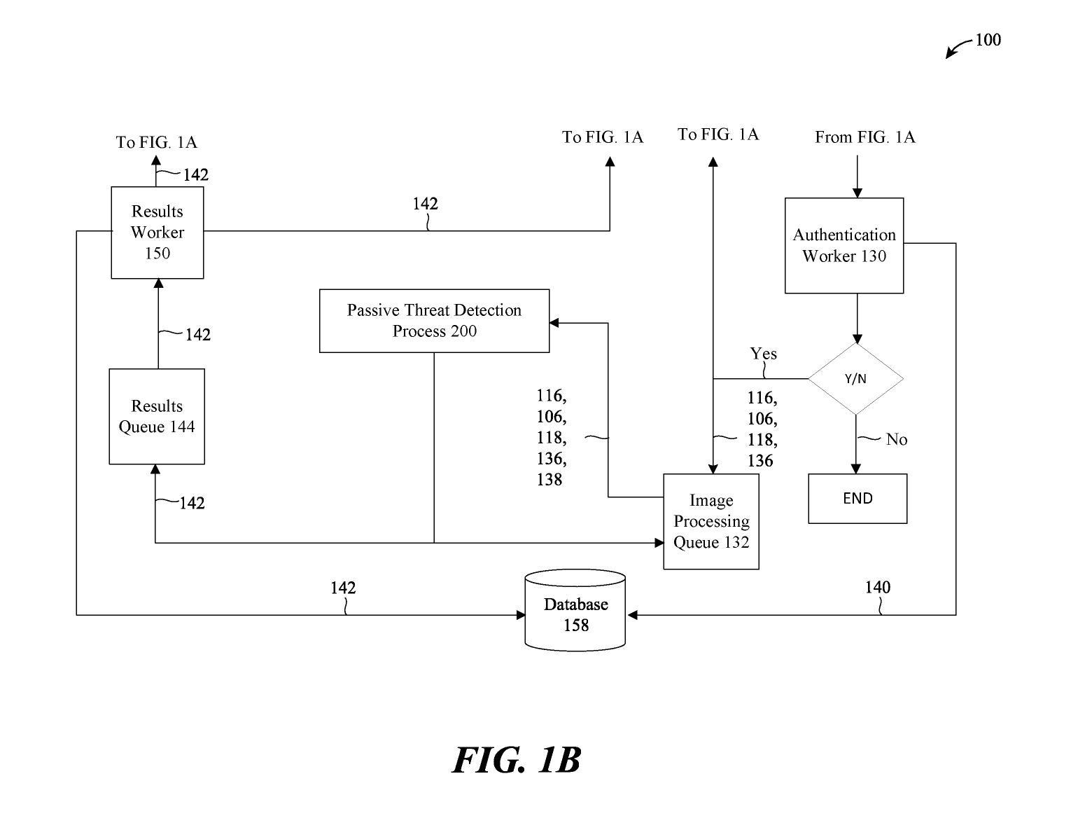

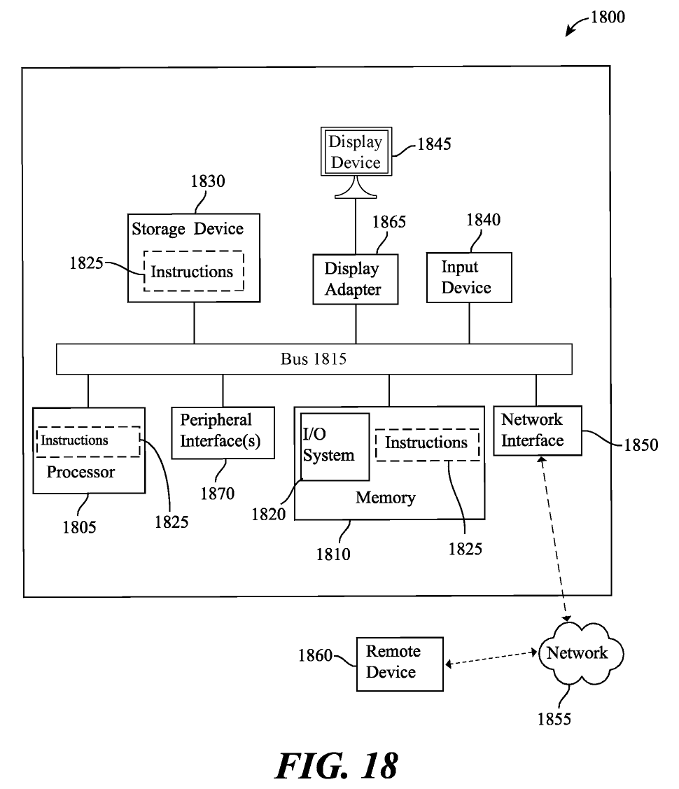

Referring now to FIGS. 1A and 1B, an embodiment of a system 100 for reverse image searching is shown. System 100 may include at least one processor. In some embodiments, the at least one processor may be consistent with processors described with reference to FIG. 18 System 100 may include a memory. The memory may be communicatively connected to the at least one processor. Memory may be consistent with memory as described with reference to FIG. 18.

With continued reference to FIGS. 1A and 1B, memory may contain instructions configuring the at least one processor to perform one or more actions. One or more actions may include any actions described in this disclosure. One or more actions, in some embodiments, may be described further with reference to FIGS. 1A- 6.

Referring now to FIGS. 1A and 1B, system 100 may include circuitry such as without limitation a processor communicatively connected to a memory; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIGS. 1A and 1B, processor may be designed and/or configured to perform any method, method step, or sequence of method steps in any embodiment described in this disclosure, in any order and with any degree of repetition. For instance, processor may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

### Dashboard / Onboarding / Receiving Input Data

With continued reference to FIGS. 1A and 1B, in some embodiments, system 100 may include a user device 102. User device 102 may include a device that a user can use to interact with or otherwise provide input to or receive output from system 100. User device 102 may include, as non-limiting examples, computers, monitors, smartphones, smartwatches, tablets, laptops, desktops, smartscreens, televisions, or the like.

With continued reference to FIGS. 1A and 1B, in some embodiments, user device 102 may include a display device. Display device may include a monitor, television, or display, as non-limiting examples. As non-limiting examples, display device may include LCD, LED, plasma, CRT, OLED, QLED, or the like. Display device may be configured to display data and/or user interfaces to a user as described throughout this disclosure.

With continued reference to FIGS. 1A and 1B, in some embodiments, user device 102 may include one or more input devices. An “input device,” for the purposes of this disclosure, is a device that allows a user to interact with a computing device so as to provide input to the computing device. In some embodiments, a user may provide an input, for example as described throughout this disclosure, using an input device. This may include, as non-limiting examples, typing on a keyboard, speaking into a microphone, clicking using a mouse, taping a touchscreen, looking at a display element using eye-tracking, or pointing at a display element using motion-tracking.

With continued reference to FIGS. 1A and 1B, system 100 may include a log in 104. In some embodiments, a user initiates a session by logging into their account through the system's 100 authentication interface. Authentication interface may be displayed using a display device of user device 102. In some embodiments, the memory may contain instructions configuring the at least a processor to receive user data 106. In some embodiments, user data 106 may include a user authentication data. In some embodiments, the memory may contain instructions configuring the at least a processor to receive user authentication data. In some embodiments, this process may be handled by an Auth microservice, which may include a dedicated backend component responsible for verifying user credentials, managing session tokens, and/or enforcing access control. Upon successful authentication, the Auth microservice may grant the user access to the system and establishes a secure session for subsequent interactions.

With continued reference to FIGS. 1A and 1B, system 100 may include a dashboard 108. Dashboard 108 may include a user interface through which a user may interface with software or a computing system. In some embodiments, dashboard 108 may include a graphical user interface.

With continued reference to FIGS. 1A and 1B, memory may include instructions configuring the at least a processor to receive, from a user, image data 112. In some embodiments, image data 112 may include an image of a face. Image data 112 may include a headshot. Image data 112 may include a security camera image. In some embodiments, user may upload image data 112 to system 100 using dashboard 108. In some embodiments, a user may upload an image directly through the Dashboard 108 interface. The submitted image may be received by the frontend and prepared for backend processing.

With continued reference to FIGS. 1A and 1B, in some embodiments, using dashboard 108, user may select a product 118 (product 118 may include a product or tier.) In some embodiments, the user may selects their desired product or service tier from the available options. In some embodiments, each product and tier may be assigned a unique identifier (ID) that is mapped to the payment processor, ensuring that the correct pricing and billing parameters are applied when the user proceeds to check-out. In some embodiments, product / tier data or the unique ID may be part of authentication data. For example, in some embodiments, user may select whether or not they would like an advanced search or a standard search. In some embodiments, user payment may be more for a advanced search than a standard search. In some embodiments, based on the results of face preprocessing 134, a user may be prompted or required to upload a different image (e.g., if the initial image quality is too poor).

With continued reference to FIGS. 1A and 1B, in some embodiments, user may enter payment details 120 using dashboard 108. In some embodiments, in the payment page, an iFrame is dynamically loaded to present the checkout interface. In some embodiments, a user may enter their payment details 120 within this iFrame. The iFrame may communicate directly with a third-party payment provider upon submission. In some embodiments, all sensitive payment data may be handled exclusively by the external payment processor. In other words, in some embodiments, system 100 may not store payment details 120 / payment data.

With continued reference to FIGS. 1A and 1B, in some embodiments, image data 112 may be stored in a database. In some embodiments, other metadata may be stored in a database, such as transaction ID, payment processor transaction ID, product/tier, and related metadata. A database may be remote to processor and communicative with processor by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local servers or personal computers. A “mesh network” as used in this disclosure is a local network topology in which the infrastructure processor connect directly, dynamically, and non-hierarchically to as many other computing devices as possible. A “network topology” as used in this disclosure is an arrangement of elements of a communication network. database may be implemented, without limitation, as a relational database, a key-value retrieval database such as a NOSQL database, or any other format or structure for use as a database that a person skilled in the art would recognize as suitable upon review of the entirety of this disclosure. database may alternatively or additionally be implemented using a distributed data storage protocol and/or data structure, such as a distributed hash table or the like. database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In an embodiment, database may be a generic storage mechanism. A generic storage mechanism may be a storage system or method that is not specific to any particular type or format of data, that is, a storage solution that provides a flexible and adaptable way to store and retrieve data without being tied to a specific data format, schema, or domain.

With continued reference to FIGS. 1A and 1B, in some embodiments, image data 112 may be uploaded 110 to a cloud based storage service. In some embodiments, cloud based storage service may include an S3 service. In some embodiments, image data 112 may be uploaded to cloud based storage service or stored in a database In some embodiments, image data 112 may be uploaded to a cloud based storage service using an image handler 114. As a non-limiting example, the uploaded image may be transmitted to cloud storage (such as AWS S3 ) using Image Handler 114. Upon successful upload, in some embodiments, the Image Handler 114 may receive and store a key 116. Key 116 may include a unique reference identifier for a stored object. In some embodiments, key may include an S3 key (a unique reference identifier for the stored image object). In some embodiments, key 116 may be retained by system 100 for subsequent use. In some embodiments, this may enable accurate retrieval of the image in later processing stages.

With continued reference to FIGS. 1A and 1B, payment details 120 may be submitted to payment processors 122. In some embodiments, iFrame may transmit payment details 120 to payment processors 122. In some embodiments, payment processors 122 may include, as non-limiting example, STRIPE or SQUARE. In some embodiments, upon submission of the payment form, the iFrame may transmit the user's payment details 120 (which may include payment credentials and the selected product 118 / tier) directly to payment processor 122. This transmission may occur entirely within a secure iFrame environment.

With continued reference to FIGS. 1A and 1B, a payment microservice may append supplementary transaction metadata to create a complete audit record. This may capture details such as the user ID, transaction ID, image key, and related contextual data, as non-limiting examples. In some embodiments, payment processor 122 may return a transaction ID upon completion. This may serve as a persistent reference to the transaction details. This transaction ID, along with the associated metadata, may be subsequently logged into the system's database. This may serve to ensure a complete and traceable record of each transaction across both the third-party payment processor and the platform's own data store.

With continued reference to FIGS. 1A and 1B, system 100 may include a payment WebSocket 124. In some embodiments, upon submission of the payment, a persistent WebSocket 124 connection between the client and the backend Payment microservice may be established to facilitate real-time communication of payment status updates. While the client remains connected, system 100 may asynchronously wait for confirmation from the third-party payment provider, which may be received using a server-side webhook. In some embodiments, payment WebSocket 124 may be configured to wait for a notification regarding payment status 126 (e.g., from a payment processor).

With continued reference to FIGS. 1A and 1B, in some embodiments, upon receipt of the payment status 126, payment microservice may process and validate the response. Then payment microservice may transmits the resulting status (e.g., success, failure, or pending) to the client through the open WebSocket connection. Based on the received status, the client application dynamically updates the user interface and, in the case of a successful transaction, redirects the user to a results loading interface for subsequent processing stages.

With continued reference to FIGS. 1A and 1B, system 100 may include a data queue 128. Data queue 128 may include a payment queue. In some embodiments, data queue 128 and/or payment queue may include an SQS queue. In some embodiments, data queue 128 and/or payment queue may include an AWS SQS queue. In some embodiments, payment queue may be used to asynchronously manage and decouple payment-related processing tasks. The payment queue stores new transaction records that have not yet been logged in the primary database. In some embodiments, each queue message may contain relevant transaction metadata, such as user ID, transaction ID, stripe payment ID, payment status, associated image key, etc. In some embodiments data queue 128 and/or payment queue may enable a queue-based approach which supports reliable, scalable, and fault-tolerant handling of payment events, allowing downstream processing to occur independently of real-time user interactions. In some embodiments, data queue 128 may receive key 116, user data 106, product 118, payment details 120, and/or payment status 126. As required by the management of tasks, authentication worker 130 may pull key 116, user data 106, product 118, payment details 120, and/or payment status 126 from data queue 128.

With continued reference to FIGS. 1A and 1B, system 100 may include an authentication worker 130. In some embodiments, authentication worker 130 may be configured to determine whether a user’s payment has been processed; thus, this may include determining whether a user has been authorized for the standard search or authorized for an advanced search. In some embodiments, authentication worker 130 may include a payment worker. In some embodiments authentication worker 130 may include a background processing component that continuously monitors and polls the queue data queue 128 for incoming transaction messages. Upon retrieving a message, authentication worker 130 may evaluate the associated payment status. If the payment is successful, authentication worker 130 may update the database with transaction details (reflecting the successful transaction state). Relevant search and processing parameters (including the key 116 and associated configuration data) may then be forwarded to the downstream queue, image processing queue 132, to initiate image analysis. If the payment is unsuccessful or invalid, authentication worker 130 may update 140 the database 158 with transaction details (reflecting the failed transaction state). This may include updating the transaction log in the database (the same row created earlier in the process) with a flag indicating whether the search was successful or failed, and whether the user received the results, ensuring a complete audit log. In this event, no further processing is triggered, and, in some embodiments, an error status is propagated to the client interface, resulting in a user-facing notification indicating the failure. In some embodiments, socket IDs 136 may be sent to image processing queue 132.

With continued reference to FIGS. 1A and 1B, in some embodiments, system 100 may be configured to perform face preprocessing 134 from uploaded image 110. Face preprocessing 134 may include extracting a plurality of facial features from the image data. In some embodiments, Image Handler 114 may assist with face preprocessing 134. For example, in some embodiments, the image may transmitted to the Image-Handler 114 microservice, which may include a dedicated backend component responsible for processing and preparing the image for downstream use. This may include validation, normalization, and facial data extraction.

With continued reference to FIGS. 1A and 1B, in some embodiments, extracted features may be shared features in image data. Feature extraction may include using a feature extractor; feature extractor may include a convolutional neural network (CNN), deep neural network (DNN), a vision transformer (ViT), resnet, multimodal feature extractors, or the like. In some embodiments, feature extractor may extract features from image data.

With continued reference to FIGS. 1A and 1B, in some embodiments, face preprocessing 134 may include a face detection and quality assessment stage. The system may be configured to analyze image data to determine whether at least one human face is present using one or more machine learning models, including but not limited to a single-shot detector, a cascaded convolutional network, a region-based convolutional neural network, or the like. In some embodiments, the face detection model may return one or more bounding box coordinates corresponding to a detected facial region, along with an associated confidence score. Image data associated with a confidence score below a predetermined threshold may be rejected or flagged. In some embodiments, the system may further perform a quality assessment on the detected facial region, evaluating one or more of: spatial resolution, image sharpness, facial pose, occlusion, and lighting conditions. Image data failing either the face detection or quality assessment stage may be rejected prior to further processing, and a corresponding rejection response may be transmitted to the client application.

With continued reference to FIGS. 1A and 1B, in some embodiments, face preprocessing 134 may include a face detection and quality assessment stage. The system may be configured to analyze image data to determine whether at least one human face is present using one or more machine learning models, including but not limited to a single-shot detector, a cascaded convolutional network, a region-based convolutional neural network, or the like. In some embodiments, face detection and quality assessment may be performed by a server-side component of the backend application, without reliance on external processing services, using one or more machine learning inference libraries executing within the backend runtime environment. The face detection model may return one or more bounding box coordinates corresponding to a detected facial region, along with an associated confidence score. Image data associated with a confidence score below a predetermined threshold may be rejected or flagged. In some embodiments, the system may further perform a quality assessment on the detected facial region, evaluating one or more of: spatial resolution, image sharpness, facial pose, occlusion, and lighting conditions. Image data failing either the face detection or quality assessment stage may be rejected prior to further processing, and a corresponding rejection response may be transmitted to the client application.

With continued reference to FIGS. 1A and 1B, in some embodiments, key 116, user data 106, product 118, socket ID 136, and/or transaction ID 138 may be sent from image processing queue 132 to passive threat detection process 200.

### Reverse Facial Lookup

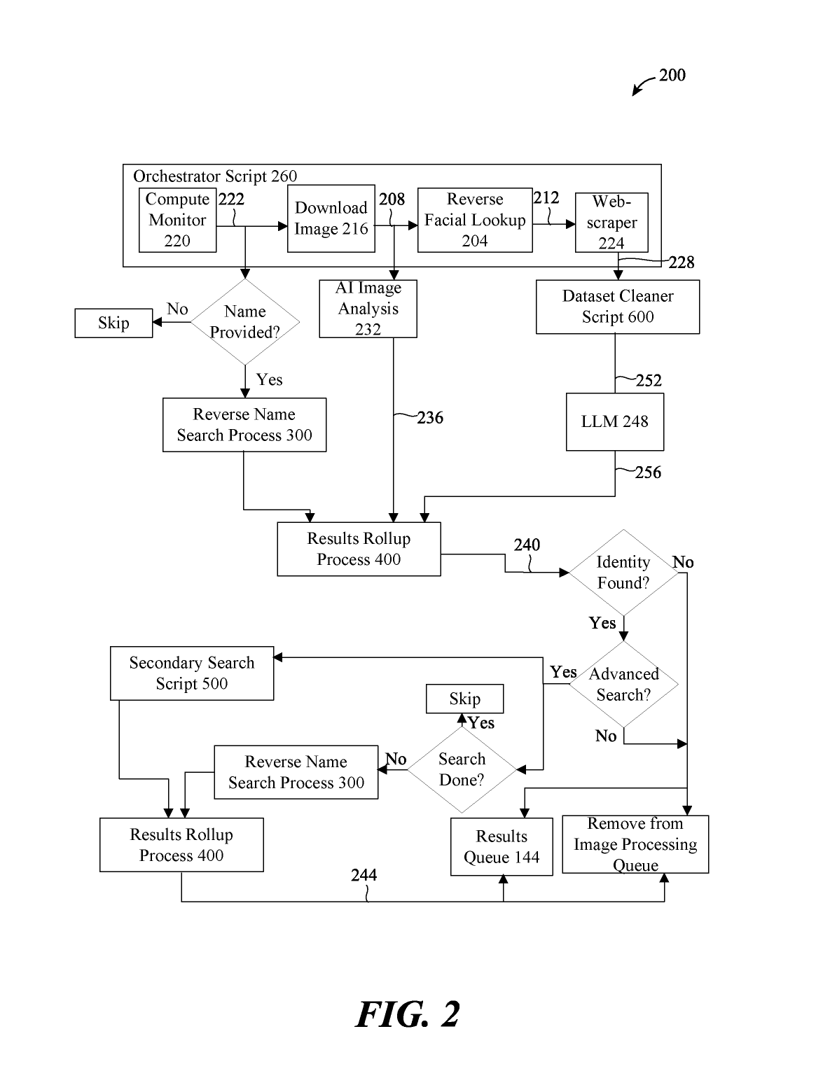

Referring now to FIG. 2, a flow diagram of an exemplary embodiment of a passive threat detection process 200 is shown. The Passive Threat Detection (PTD) process 200 may include an automated, multi-stage identity research workflow that may construct a structured personal profile of an individual from one or more identity inputs, such as a facial image and/or name. In some embodiments, beginning with facial recognition against indexed web content, passive threat detection process 200 may progressively gather, clean, and process data associated with the identified face and, where available, name. Passive threat detection process 200 may resolve this data into one or more comprehensive identity profiles that are returned to the requesting system upon completion.

With continued reference to FIG. 2, in some embodiments, passive threat detection process 200 may be organized into two tiers of operation. In a standard tier, in some embodiments, passive threat detection process 200 may perform facial recognition against indexed web content, scrape and clean the resulting source pages, extract structured identity fields using a language model, merge into or split those per-source extractions into one or more profiles. , and return the result. In an advanced tier, in some embodiments, the standard tier workflow may be executed first, and its interim profile output may be then used to seed one or more additional enrichment stages, a secondary records search and/or an optional reverse name search. In passive threat detection process 200 a final results rollup may consolidate all collected data into a final output profile.

With continued referenced to FIG. 2, in some embodiments, work items may enter and exit the pipeline using managed queues. As a non-limiting example, images awaiting processing may be held in image processing queue 132 and completed profile results 142 may be delivered to results queue 144. This queue-based architecture is a technical improvement because it decouples each processing stage from the others, allowing stages to operate at independent concurrency levels and enabling the pipeline to recover gracefully from transient failures without losing work.

With continued reference to FIG. 2, in some embodiments, passive threat detection process 200 may include a reverse facial lookup 204. Reverse facial lookup 204 may receive several input fields to initiate processing: key 116 (associated with the user- submitted image), a designated search tier that may determines the scope and priority of the detection pipeline (for example, this may be determined from the product 118 choice of the user), an optional user-provided name, the User ID, and the like. In some embodiments, passive threat detection process 200 may receive all of the forgoing data, whereas reverse facial lookup 204 may only receive or use an image. These inputs may collectively parameterize the subsequent processing stages and establish the operational context for the passive threat detection process 200.

With continued reference to FIG. 2, reverse facial lookup process 204 may be performed on the image 208 to identify potential matches across various data sources. Reverse facial lookup 204 may include analyzing the facial features within image 208. Then reverse facial lookup 204 may include returning a set of candidate results 212.

With continued reference to FIG. 2, in some embodiments, passive threat detection process 200 may include a step of downloading the image 216. A compute monitor 220 may be configured to continuously monitor the availability of compute resources. This may include a step of downloading the image 216 from cloud-based storage. Cloud based storage may include S3 or AWS S3. When available resources are detected, compute monitor 220 may be configures to spawn a dedicated processing thread and poll the next pending job from image processing queue 132. This may represent a technical improvement as the polling mechanism may ensure that compute resources are allocated dynamically and that image processing tasks are dispatched in an orderly, queue-driven manner. Once a job is pulled from the queue, a retrieval operation may be initiated to perform the step of downloading the image 216 from cloud object storage (e.g. AWS S3); this may include job info 222.

With continued reference to FIG. 2, in some embodiments, performing reverse facial lookup 204 may include comparing the plurality of facial features to a plurality of candidate results. This may include comparing the plurality of facial features to a plurality of candidate results. In some embodiments, this may be done by calculating distance metrics between the facial features and the candidate results. Distance metrics may include, as non-limiting examples, Euclidian distance, Manhattan distance and/or cosine similarity. As a function of include comparing the plurality of facial features to a plurality of candidate results confidence scores for the candidate results may be determined. For example, larger distance metrics may be associated with lower confidence scores, whereas smaller distance metrics may be associated with higher confidence scores. In some embodiments, distance metrics for a plurality of attributes (or features) may be calculated and then averaged together to determine an average distance metric.

In some embodiments, performing the reverse facial lookup may include performing, using the at least one processor, a reverse facial lookup, wherein performing the reverse facial lookup comprises: inputting the plurality of facial features; and receiving, in response to the plurality of facial features, a subset of the candidate results. This may include performing the steps of the reverse facial lookup on system 100, or it may include interfacing with an API as described below.

In some embodiments, performing a reverse facial lookup may include performing a reverse facial lookup using a reverse facial lookup API. For example, reverse facial lookup API may be queried and receive image 208. Reverse facial lookup API may return set of candidate results 212.

With continued reference to FIG. 2, in some embodiments, a subset of the candidate results 212 may be returned as a function of the confidence scores. In some embodiments, returned candidate results 212 may be filtered to remove entries that fall below a predefined confidence threshold. This may ensure that only sufficiently probable matches are retained for further processing. For example, set of candidate results 212 with a confidence score below a threshold may be excluded from the subset of set of candidate results 212.

With continued reference to FIG. 2, in some embodiments, returning the subset of the candidate results 212 as a function of the confidence scores may include receiving uniform resource locators (URLs) associated with the candidate results 212. In some embodiments, the URLs may be sent to a web scraper 224. Web scraper 224 may be configured to retrieve scraped data associated with the URLs. In this way, the resulting set of URLs may serve as input for downstream data extraction and analysis stages.

With continued reference to FIG. 2, web scraper 224 may be applied to the filtered set of URLs obtained from reverse facial lookup 204. The URLs may be first prioritized based on source quality metrics, which may include domain credibility, data relevance, and historical reliability. Following prioritization, in some embodiments, the top-ranked sources are accessed and parsed to extract relevant content associated with the identified individual. In some embodiments, if social media URLs are detected then individual web scrapers and/or API calls may be used to scrape data from social media site such as, as non-limiting examples, LINKEDIN, TWITTER (or X), INSTAGRAM, FACEBOOK, THREADS, BLUESKY, or the like. In some embodiments, the initial search may analyze the URLs and proceed to look for name, age, residency, occupation, warrants, and criminal records.

With continued reference to FIG. 2, web scraper 224 may also be known as a web-spider or web-robot, is an automated program or script designed to browse the internet systematically and collect data from websites. Web scraper 224 may start with a list of URLs and follow links on those pages to discover and index new content (for example, filtered set of URLs). The web scraper 224 may retrieve web pages, analyze their content, and store relevant information in a database or other data structure. Components of a web scraper 224 may include URL queue, a downloader, a parser, and storage. The URL queue is a list of URLs to visit, which may be dynamically updated as new links are discovered. The downloader is a component that retrieves web pages from the internet. A parser analyzes the content of the downloaded pages, extracting useful data and identifying new links. Further, storage may include a database and/or a file system where the scraped data may be stored for future retrieval and analysis. Web scraper 224 may output scraped content 228; in some embodiments, to a dataset cleaner script 600.

### AI Image Analysis

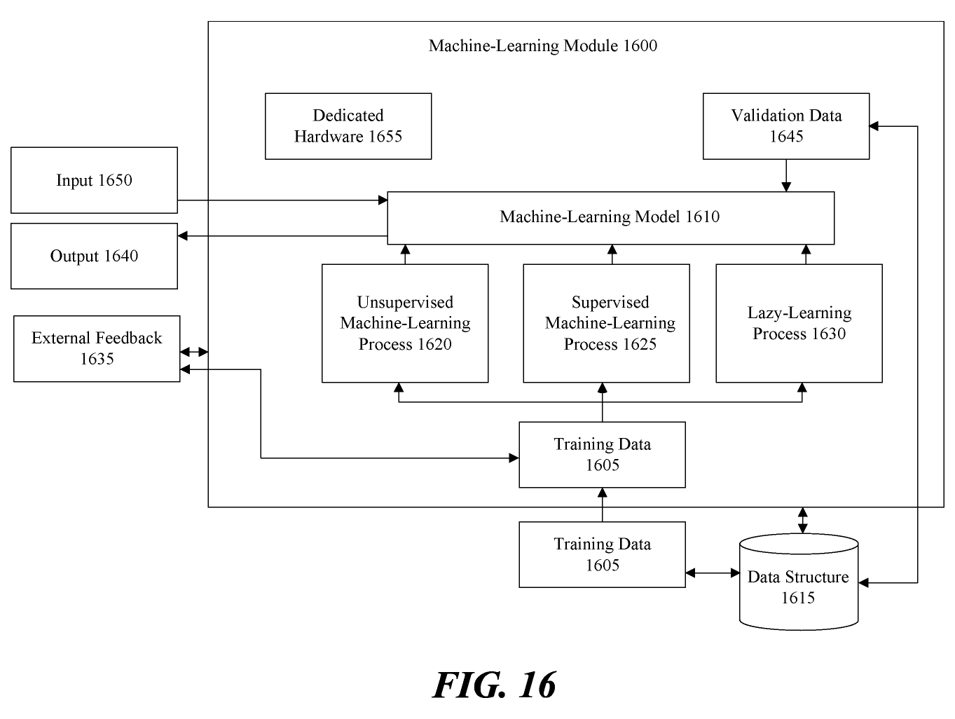

With continued reference to FIG. 2, passive threat detection process 200 may include an AI image analysis 232. In some embodiments, memory may include instructions configuring the processor to perform AI image analysis 232. AI image analysis 232 may include inputting the plurality of facial features into an image analysis model. Image analysis model may include a machine-learning model; for example, image analysis model may include a machine-learning model trained using machine-learning module 1600 of FIG. 16. Image analysis model may be trained using training data correlating, e.g., facial features to demographic characteristics. In some embodiments, image analysis model may be iteratively trained using a cost function in order to teach the model to accurately identify demographic characteristics based on the training data. The training process may involve iteratively updating one or more weights of the model as a function of the training. Performing AI image analysis 232 may include receiving an AI output 236 from the image analysis model. In some embodiments, AI output 236 may include a set of estimated demographic characteristics. Demographic characteristics may include, as non-limiting examples, age, race, gender, sex, and/or ethnicity.

Referring to FIG. 2, In some embodiments, AI output 236 may include an artificial generation likelihood score. This may include a qualitative or quantitative measure of the likelihood that the image is AI generated. In some embodiments, image analysis model may include a classifier, wherein the classifier is configured to classify the image or facial features to either “AI generated” or “not AI generated.” Classifier may be configured to output a confidence score associated with this classification. Classifier may include as non-limiting examples, linear discriminant analysis (LDA), k-nearest neighbors (KNN), Naïve Bayes, gaussian mixture model, and/or margin based classifiers. Classifier may be trained using classifier training data. Classification training data may include facial features or image data correlated to a classification associated with either being or not being AI generated. For example, classification training data may include exemplary inputs correlated to exemplary output classifications. Classifier may be trained using classification training data using, as non-limiting examples, an eager learning algorithm or a lazy learning algorithm.

In some embodiments, AI image analysis 232 may be conducted using an API. For example, inputs to AI image analysis 232 may be provided over API to an image analysis service. The image analysis service may conduct the analysis (e.g., remotely) and return the AI output 236.

In some embodiments, each attribute in AI output 236 may include a corresponding confidence score representing the model’s certainty. These outputs may be retained and used as weighted inputs in subsequent analysis stages, enabling downstream processes to incorporate probabilistic reasoning and confidence-based filtering.

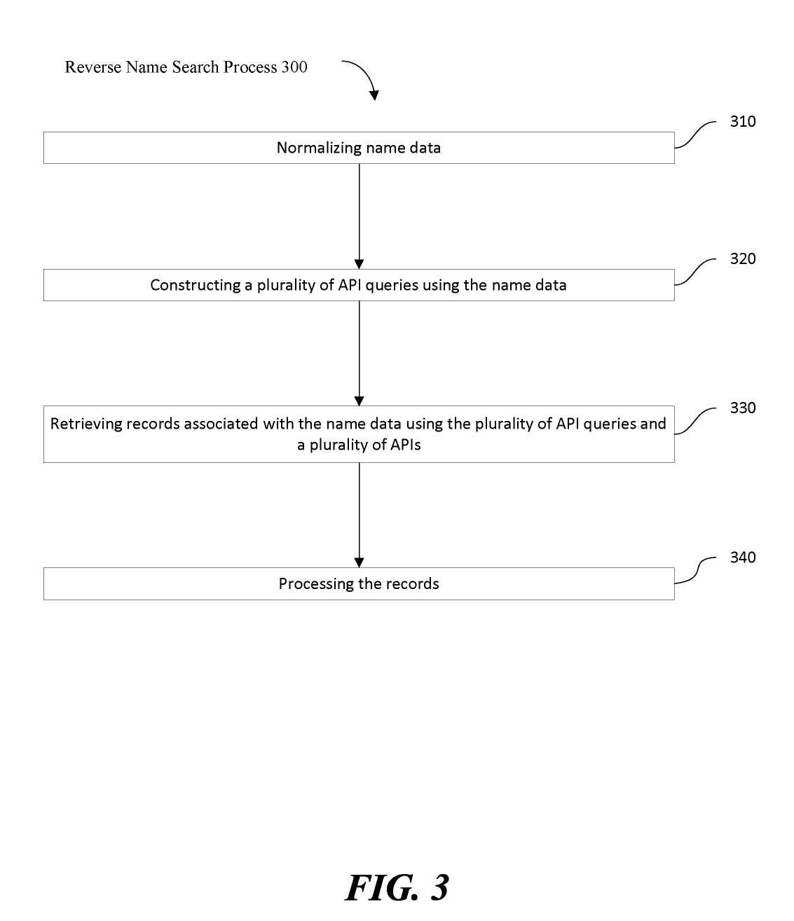

Referring to FIGS. 2 and 3, in some embodiments, passive threat detection process 200 may include a reverse name search 300. As a preliminary matter before initiating, reverse name search 300, passive threat detection process 200 may include determining or checking whether name data has been received from the user. If the name data has been received, then passive threat detection process 200 may include conducting reverse name search 300. If the name data has not been received, then reverse name search 300 may be skipped or omitted.

With continued reference to FIGS. 2 and 3, performing reverse name search 300 may include a step 310 of normalizing the name data. The system may begin by normalizing the user-provided name input. This may include standardizing formatting (e.g., capitalization, removal of extraneous characters, and handling of aliases or common variations) to ensure consistency and improve search accuracy across downstream services.

With continued reference to FIGS. 2 and 3, reverse name search 300 may include a step 320 of constructing a plurality of API queries using the name data. In some embodiments, once normalized, the name may be used to construct search queries that are executed across multiple data sources, including external APIs and web-based search endpoints. These queries are designed to retrieve relevant records associated with the provided name, such as public profiles, indexed pages, and database entries.

With continued reference to FIGS. 2 and 3, reverse name search 300 may include a step 330 of retrieving records associated with the name data using the plurality of API queries and a plurality of APIs. The system may aggregates responses from these sources for further processing.

With continued reference to FIGS. 2 and 3, reverse name search 300 may include a step 340 of processing the records. The returned data may then be processed through a parsing pipeline. Unstructured and semi-structured content may be analyzed to extract relevant attributes (e.g., associated identifiers, locations, affiliations). This information is converted into a structured format, enabling consistent storage and downstream analysis.

Data parsing and analysis as described throughout this disclosure may include natural language processing. As used in the current disclosure, a “natural language processing (NLP) model” is a computational model designed to process and understand human language. It leverages techniques from machine learning, linguistics, and computer science to enable computers to comprehend, interpret, and generate natural language text. The NLP model may preprocess the textual data, wherein the input text may include all text contained within the names or scraped data its associated metadata, or any other data mentioned herein. Preprocessing the input text may involve tasks like tokenization (splitting text into individual words or sub-word units), normalizing the text (lowercasing, removing punctuation, etc.), and encoding the text into a numerical representation suitable for the model. The NLP model may include transformer architecture, wherein the transformers are deep learning models that employ attention mechanisms to capture the relationships between words or sub-word units in a text sequence. They consist of multiple layers of self-attention and feed-forward neural networks. The NLP model may weigh the importance of different words or sub-word units within a text sequence while considering the context. It enables the model to capture dependencies and relationships between words, considering both local and global contexts. This process may be used to identify a plurality of named entities. Language processing model may include a program automatically generated by a processor and/or named entity recognition system to produce associations between one or more significant terms extracted from the names or scraped data its associated metadata and detect associations, including without limitation mathematical associations, between such significant terms. Associations between language elements, where language elements include for purposes herein extracted significant terms, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted significant term indicates a given category of semantic meaning. As a further example, statistical correlations and/or mathematical associations may include probabilistic formulas or relationships indicating a positive and/or negative association between at least an extracted significant term and/or a given semantic relationship; positive or negative indication may include an indication that a given document is or is not indicating a category semantic relationship. Whether a phrase, sentence, word, or other textual element in the names or scraped data its associated metadata constitutes a positive or negative indicator may be determined, in an embodiment, by mathematical associations between detected significant terms, comparisons to phrases and/or words indicating positive and/or negative indicators that are stored in memory at a processor, or the like.

### Results Rollup

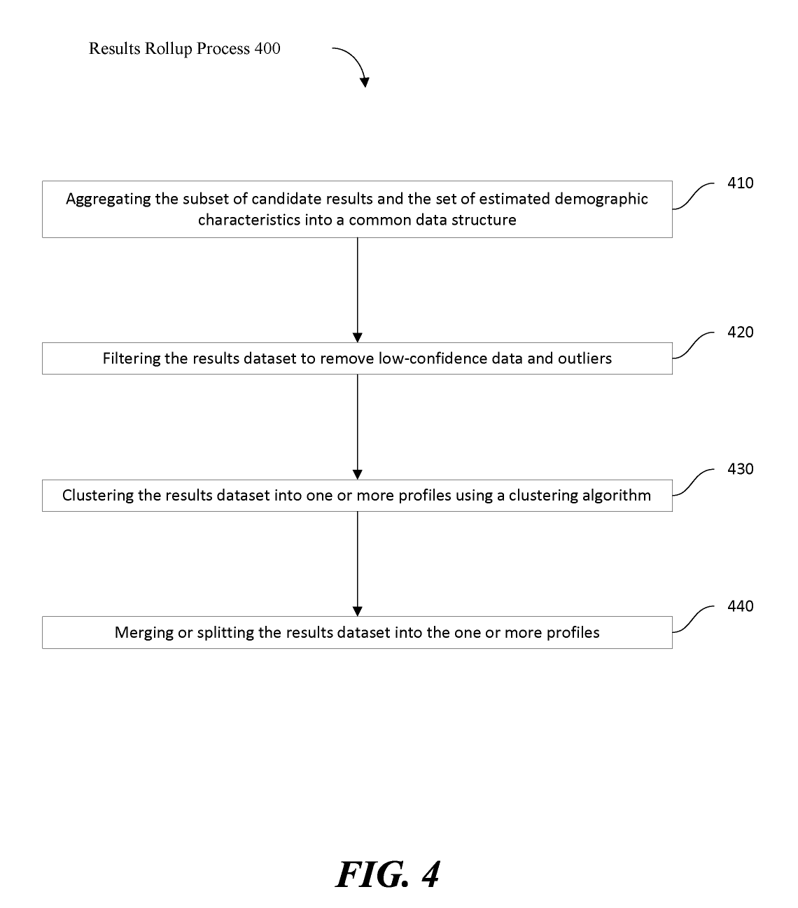

Referring now to FIGS. 2 and 4, passive threat detection process 200 may include a results rollup process 400. Process 400 may include consolidating and refining data collected from prior search processes into coherent identity profiles through a multi-stage aggregation and validation pipeline.

With continued reference to FIGS. 2 and 4, process 400 may include a step 410 of aggregate the subset of candidate results and the set of estimated demographic characteristics into a results dataset. Results dataset may include a common data structure that consolidates the info from upstream data processes. Extracted data may be aggregated into a tabular structure, aligning fields across multiple sources. Duplicate records may be identified and removed, while overlapping data points are cross-referenced to validate consistency and improve data reliability. Duplicating and overlapping data may be identified be calculating distance metrics between the data embeddings and removing duplicate sets of data lower distance metrics.

With continued reference to FIGS. 2 and 4, process 400 may include a step 420 of filtering the results dataset to remove low-confidence data and outliers. In some embodiments, outlier analysis may include statistical analysis to determine outliers. In some embodiments, “low-confidence” data may be identified using confidence scores as calculated by upstream processes. In some embodiments, the system may apply scoring mechanisms to evaluate the confidence of each data point. Entries that fall below defined confidence thresholds, or that significantly deviate from consensus patterns across sources, may be filtered out to reduce noise and improve overall accuracy.

With continued reference to FIGS. 2 and 4, process 400 may include a step 430 of clustering the results dataset into one or more profiles using a clustering algorithm. The data may be grouped based on identity signals using field-level similarity (e.g., name, location, affiliations). Clustering algorithms may assess coherence across attributes to determine which data points likely correspond to the same individual. Clustering algorithms may include, as non-limiting examples, means clustering, hierarchical clustering, DBSCAN (Density-Based Spatial Clustering of Applications with Noise), Gaussian Mixture Models (GMMs), and Spectral Clustering.

With continued reference to FIGS. 2 and 4, process 400 may include a step 440 of merging or splitting the results dataset into the one or more profiles 240. Based on clustering results, the process resolves whether data should be merged into a single unified profile or separated into multiple distinct profiles. This step ensures accurate representation of one or more identities, minimizing false associations. This step may include classification algorithms as described above.

### Advanced Search

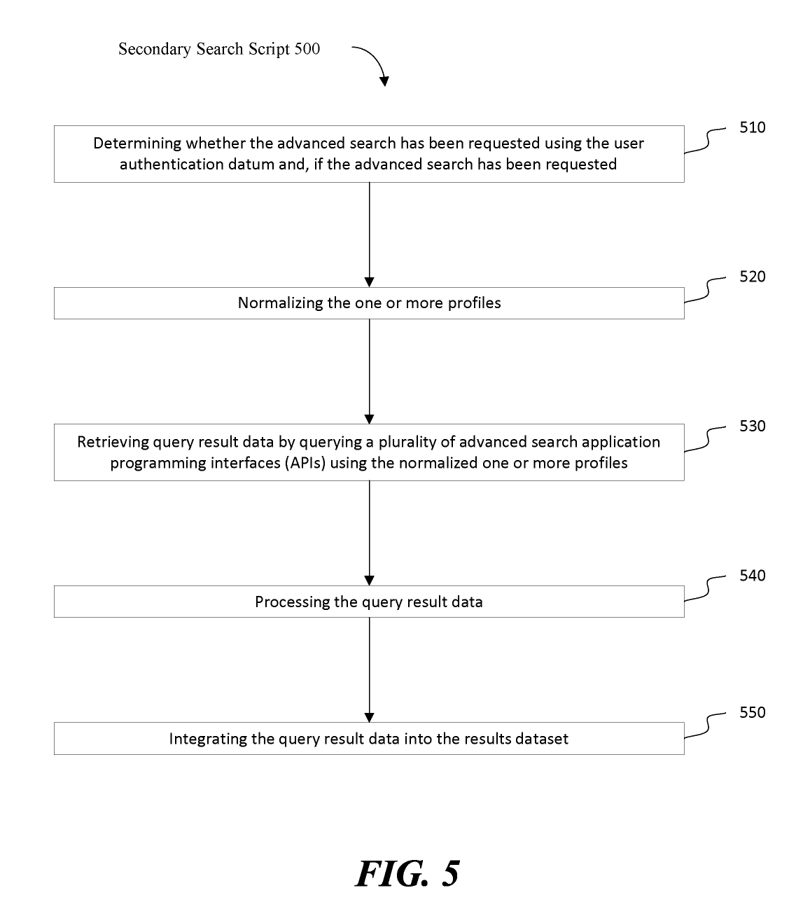

Referring to FIGS. 2 and 5, if an identity has been successfully identified during the Base Search process (e.g., based on one or more profiles 240), and if the user has selected the advanced search tier, then the system may initiate the secondary search script 500. Otherwise, this process is skipped. Secondary search script 500 may include a step 510 of determining whether the advanced search has been requested using the user authentication datum and, if the advanced search has been requested.

With continued reference to FIGS. 2 and 5, secondary search script 500 may include a step 520 of normalizing the one or more profiles. In some embodiments, step 520 may include using a query builder. The query builder may normalize the identified profile associated with the resolved identity by extracting key attributes. This process may include actions such as resolving known variations and structuring the data into a standardized format suitable for expanded query generation. This may take as input the Name, Age, and residency from initial search.

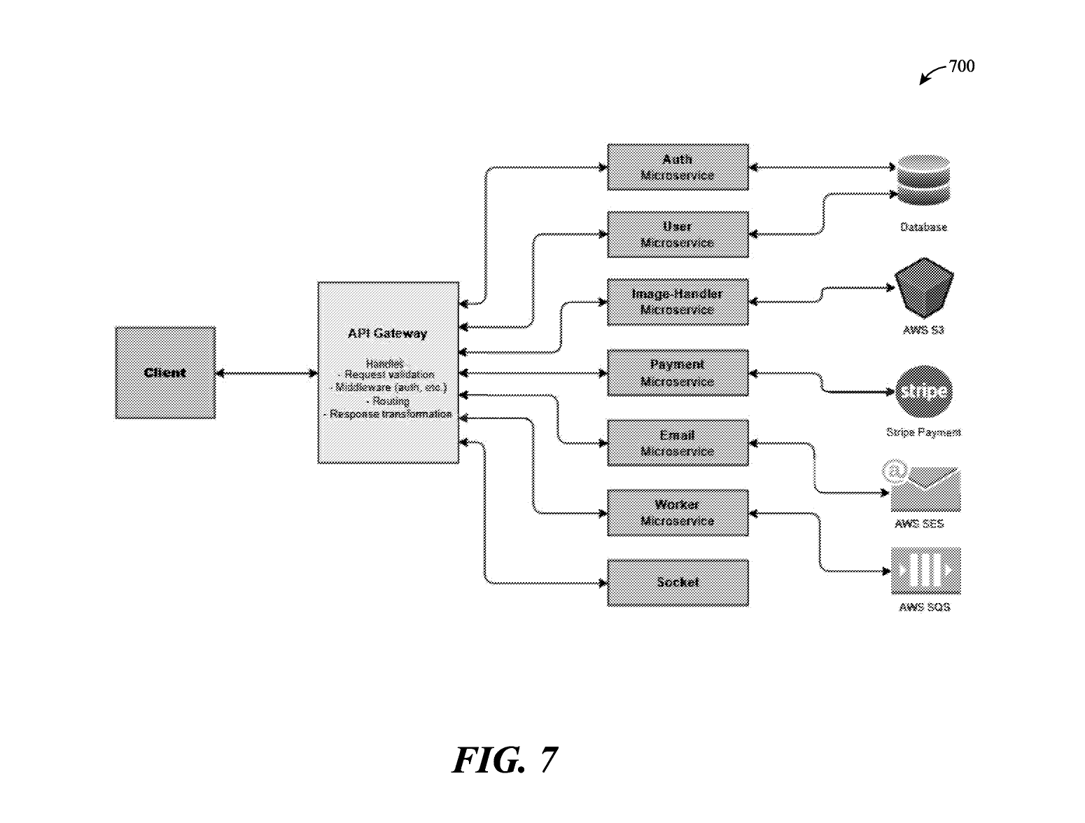

With continued reference to FIGS. 2 and 5, secondary search script 500 may include a step 530 of retrieving query result data by querying a plurality of advanced search application programming interfaces (APIs). In some embodiments, this may include using the normalized profiles. APIs are further described with reference to FIG. 7. APIs may include, as non-limiting examples, any of the APIs described with reference to FIG. 7. In some embodiments, using the found identity, the system may execute additional queries across an extended set of data sources, including premium APIs, deeper web indexes, and specialized databases. These queries may be designed to retrieve more comprehensive and higher-confidence data associated with the identified individual. In some embodiments, this may include, querying other databases to find and verify more information on the person. In certain aspects, the secondary search includes sex offender registry's, criminal databases, and the like.

With continued reference to FIGS. 2 and 5, secondary search script 500 may include a step 540 of processing the query results. Processing the query results may include receiving results from the APIs as described above.

With continued reference to FIGS. 2 and 5, secondary search script 500 may include a step 550 of integrating the query result data into the results dataset. In some embodiments the returned data may be processed through a structured extraction pipeline. Scraping and parsing mechanisms may analyze both structured and unstructured content to extract relevant attributes (e.g., affiliations, historical records, associated entities, etc.). The extracted data is normalized and formatted for integration with previously collected results.

With continued reference to FIGS. 2 and 5, if a Reverse Name Search 300 has not already been executed, and if the advanced search tier was selected, then the system may initiate reverse name search 300 process at this stage. Otherwise, the reverse name search 300 is skipped to prevent redundant operations. This conditional execution represents a technical improvement as it ensures that all available identity-linked data pathways are explored while maintaining system efficiency by avoiding duplicate searches. This improves computational efficiency and allows for more efficient use of computational resources.

With continued reference to FIGS. 2 and 5, if the advanced search tier was selected, an additional Results Rollup 400 execution is performed after all enrichment stages have completed. This step may retrieve the interim profile or profiles produced by the standard-tier results rollup, the structured records returned by the secondary search script 500, and, where a candidate name was available and reverse name search 300 was executed, the results of that reverse name search 300. These three data sets may be merged into a single expanded input corpus and passed through the same Results Rollup 400 logic. Because process 400 and reverse name search 300 sources are typically higher in structured data density than the facial-recognition-sourced web pages processed in the standard tier (e.g., returning records such as address histories, court filings, and public registry entries), this second rollup pass frequently resolves ambiguities that the first pass could not, and produces profiles with materially higher field completeness and confidence scores. Therefore, this unique dual stage rollup process represents a technical improvement in the field of data processing. The output of this step may include one or more updated profile objects (e.g., final results 244) that may supersede the interim profiles produced previously.

### Data Cleaner Script

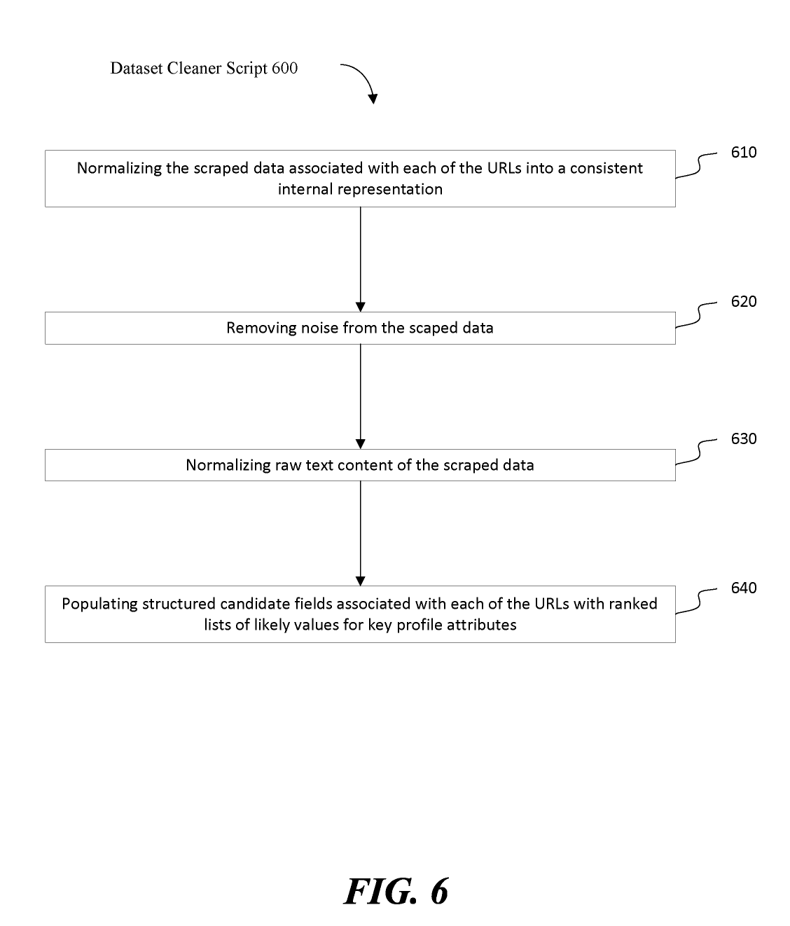

Referring now to FIGS. 2 and 6, passive threat detection process 200 may include a data cleaner script 600. In some embodiments, dataset cleaner script 600 may receive scraped content 228 from web scraper 224. In some embodiments, dataset cleaner script 600 may clean the scraped content 228 from web scraper 224.

With continued reference to FIGS. 2 and 6, dataset cleaner script 600 may include a step 610 of normalizing the scraped data associated with each of the URLs into a consistent internal representation. Raw data may be ingested from a JSON file produced by the web scraper 224. The dataset cleaner script 600 may support multiple input format variants, detecting the structure at runtime and normalizing each page payload into a consistent internal representation. For each page, a priority-ordered probe may select the best available text field. Metadata fields (title, author, description, published date, etc.) may be extracted from a structured allowlist and normalized using, as a non-limiting example, a script such as Python's urllib.parse and datetime libraries. Published dates may be resolved through a four-layer fallback hierarchy: structured metadata fields, date patterns extracted from the URL path, date patterns extracted from the raw text body, and date patterns extracted from the page title.

With continued reference to FIGS. 2 and 6, dataset cleaner script 600 may include a step 620 of removing noise from the scraped content 228. In some embodiments, dataset cleaner script 600 may include a step 630 of normalizing raw text content of the scraped data. For example, in some embodiments, the raw text may undergo a multi-step cleaning pipeline. Markdown formatting may be stripped to plain text. Unicode punctuation may be normalized to ASCII equivalents. Boilerplate content (including, as non-limiting examples, navigation text, cookie consent blocks, subscription prompts, social sharing elements, and legal/policy language) may be identified and removed using curated keyword lists and regex-based pattern matching (as non-limiting examples (“search,” “please subscribe,” TWITTER sharing buttons, and the like). Duplicate and near-duplicate content blocks may be identified and suppressed using MD5 hashing. Long paragraphs may be segmented into coherent chunks using sentence-boundary detection and a discourse-pivot heuristic that identifies natural topic transitions. Content following feed or footer markers (e.g., "Related Articles", "You May Also Like") may be truncated. This may include the use of natural language processing.

With continued reference to FIGS. 2 and 6, dataset cleaner script 600 may include a step 640 of populating structured candidate fields associated with each of the URLs with ranked lists of likely values for key profile attributes. From the cleaned text, the script may populate structured candidate fields for each source page. These fields may serve as pre-computed identity signals passed to the downstream LLM extraction stage; for example, providing ranked lists of likely values for key profile attributes so the model can evaluate and select from plausible candidates rather than extracting from scratch. Each candidate value may carry an associated confidence score reflecting the strength of the contextual evidence supporting it. These fields may include but are not limited to: a facts-only list, which extracts high-signal sentences using length filters, a fact-signal gate (as non-limiting examples, requiring legal/news verbs, named entities, or temporal markers), and deduplication. Person name candidates, which may be scored from multiple sources (as non-limiting examples, URL slugs, page title, body text frequency, co-occurrence with age expressions, and alias patterns) then may be filtered through a cascading rejection chain that removes, as non-limiting examples, location strings, organizational entities, job title phrases, and names lacking identity-context support. Age and date-of-birth candidates, which may be extracted using various regex patterns covering common age expression formats, where a parse-able DOB is found, a derived integer age may be computed relative to the page's published date. Location candidates, which may be extracted through precision tiers ranging from explicitly labeled fields ("Location: City, ST") down to preposition-introduced place names, with filtering to prevent person names and common non-place words from being misclassified as locations.

### LLM

Referring to FIG. 2, a large language model (LLM) 248 may receive cleaned scraped data 252 from dataset cleaner script 600. LLM 248 may process the aggregated and cleaned data collected from prior stages. Each source-specific dataset may be independently analyzed to identify and extract structured profile attributes associated with the subject, producing a distinct profile output per input source. Passive threat detection process 200 may include inputting each set of cleaned scraped data into LLM 248. In some embodiments, passive threat detection process 200 may include generating, using LLM 248, structured profile attributes 256 associated with a subject. Extracted attributes may include, but are not limited to, name, age, occupation, affiliated organizations, educational background, geographic location, criminal records, and publicly available records. The LLM 248 may be configured to normalize and organize this information into a consistent profile representation, enabling downstream aggregation, comparison, and analysis across multiple sources. For example, LLM 248 may be prompted with “based on [cleaned scraped data 252], please identify the attributes including , name, age, occupation, affiliated organizations, educational background, geographic location, criminal records, and publicly available records.”

With continued reference to FIG. 2, LLM 248 may include an instruction-tuned transformer model. Instruction-tuned transformer model may be fine-tuned on examples of: Instruction / Prompt: “extract attributes” and Desired Response: [structured profile attributes 256]. In some embodiments, each inputted set of cleaned scraped data 252 may be provided to the LLM as a structured JavaScript Object Notation (JSON) file. In some embodiments, the instruction-tuned transformer model may be constrained to produce strictly formatted JSON outputs with predefined fields. This provides a technical benefit of , ensuring consistency and compatibility with downstream processing components. In one embodiment, LLM 248 may utilizes an instruction-tuned transformer model, such as, as a non-limiting example, Mistral-7B- Instruct-v0.1. Input may be provided as structured JSON generated during prior web scraping and preprocessing stages, allowing for efficient parsing and context-aware extraction. The model is constrained to produce strictly formatted JSON outputs with predefined fields, ensuring consistency and compatibility with downstream processing components.

With continued reference to FIG. 2, a “large language model,” or “LLM,” as used herein, is a deep learning data structure that can recognize, summarize, translate, predict and/or generate text and other content based on knowledge gained from massive datasets. Large language models may be trained on large sets of data. Training sets may be drawn from diverse sets of data such as, as non-limiting examples, novels, blog posts, articles, emails, unstructured data, electronic records, and the like. In some embodiments, training sets may include a variety of subject matters, such as, as nonlimiting examples, academic report documents, entity documents, business documents, inventory documentation, emails, user communications, advertising documents, newspaper articles, and the like. In some embodiments, training sets of an LLM may include information from one or more public or private databases. As a non-limiting example, training sets may include databases associated with an entity. In some embodiments, training sets may include portions of documents associated with the electronic records correlated to examples of outputs. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities.

With continued reference to FIG. 2, in some embodiments, an LLM may be generally trained. As used in this disclosure, a “generally trained” LLM is an LLM that is trained on a general training set comprising a variety of subject matters, data sets, and fields. In some embodiments, an LLM may be initially generally trained. Additionally, or alternatively, an LLM may be specifically trained. As used in this disclosure, a “specifically trained” LLM is an LLM that is trained on a specific training set, wherein the specific training set includes data including specific correlations for the LLM to learn. For example, LLM may be specifically trained on the ASIC framework as described throughout this disclosure. As a non-limiting example, an LLM may be generally trained on a general training set, then specifically trained on a specific training set. In an embodiment, specific training of an LLM may be performed using a supervised machine learning process. In some embodiments, generally training an LLM may be performed using an unsupervised machine learning process. As a non-limiting example, specific training set may include information from a database. As a non-limiting example, specific training set may include text related to the users such as user specific data for electronic records correlated to examples of outputs. In an embodiment, training one or more machine learning models may include setting the parameters of the one or more models (weights and biases) either randomly or using a pretrained model. Generally training one or more machine learning models on a large corpus of text data can provide a starting point for fine-tuning on a specific task. A model such as an LLM may learn by adjusting its parameters during the training process to minimize a defined loss function, which measures the difference between predicted outputs and ground truth. Once a model has been generally trained, the model may then be specifically trained to fine-tune the pretrained model on task-specific data to adapt it to the target task. Fine-tuning may involve training a model with task-specific training data, adjusting the model's weights to optimize performance for the particular task. In some cases, this may include optimizing the model's performance by fine-tuning hyperparameters such as learning rate, batch size, and regularization. Hyperparameter tuning may help in achieving the best performance and convergence during training. In an embodiment, fine-tuning a pretrained model such as an LLM may include fine-tuning the pretrained model using Low-Rank Adaptation (LoRA). As used in this disclosure, “Low-Rank Adaptation” is a training technique for large language models that modifies a subset of parameters in the model. Low-Rank Adaptation may be configured to make the training process more computationally efficient by avoiding a need to train an entire model from scratch. In an exemplary embodiment, a subset of parameters that are updated may include parameters that are associated with a specific task or domain.

With continued reference to FIG. 2, in some embodiments an LLM may include and/or be produced using Generative Pretrained Transformer (GPT), GPT-2, GPT-3, GPT-4, and the like. GPT, GPT-2, GPT-3, GPT-3.5, and GPT-4 are products of Open AI Inc., of San Francisco, CA.

Still referring to FIG. 2, an LLM may include a transformer architecture. In some embodiments, encoder component of an LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 2, an LLM and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation.

With continued reference to FIG. 2, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM may predict the next word by searching for a set of positions in a source sentence where the most relevant information is concentrated. An LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 2, attention mechanism may include, without limitation, generalized attention self-attention, multi-head attention, additive attention, global attention, and the like. In generalized attention, when a sequence of words or an image is fed to an LLM, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, an LLM may pick up particular parts at different positions in the input sequence and over time compute an initial composition of the output sequence. In multi-head attention, an LLM may include a transformer model of an attention mechanism. Attention mechanisms, as described above, may provide context for any position in the input sequence. For example, if the input data is a natural language sentence, the transformer does not have to process one word at a time. In multi-head attention, computations by an LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM may either attend to all source words or predict the target sentence, thereby attending to a smaller subset of words.

With continued reference to FIG. 2, multi-headed attention in encoder may apply a specific attention mechanism called self-attention. Self-attention allows models such as an LLM or components thereof to associate each word in the input, to other words. As a non-limiting example, an LLM may learn to associate the word “you,” with “how” and “are.” It’s also possible that an LLM learns that words structured in this pattern are typically a question and to respond appropriately. In some embodiments, to achieve self-attention, input may be fed into three distinct fully connected neural network layers to create query, key, and value vectors. A query vector may include an entity’s learned representation for comparison to determine attention score. A key vector may include an entity’s learned representation for determining the entity’s relevance and attention weight. A value vector may include data used to generate output representations. Query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

Still referencing FIG. 2, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

With continued reference to FIG. 2, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

Continuing to refer to FIG. 2, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With further reference to FIG. 2, in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 2, first multi-headed attention layer may be configured to not condition to future tokens. As a non-limiting example, when computing attention scores on the word “am,” decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filled with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves zero attention scores for “future tokens.”

Still referring to FIG. 2, second multi-headed attention layer may use encoder outputs as queries and keys and the outputs from the first multi-headed attention layer as values. This process matches the encoder’s input to the decoder’s input, allowing the decoder to decide which encoder input is relevant to put a focus on. The output from second multi-headed attention layer may be fed through a pointwise feedforward layer for further processing.

With continued reference to FIG. 2, the output of the pointwise feedforward layer may be fed through a final linear layer. This final linear layer may act as a classifier. This classifier may be as big as the number of classes that you have. For example, if you have 10,000 classes for 10,000 words, the output of that classifier will be of size 10,000. The output of this classifier may be fed into a softmax layer which may serve to produce probability scores between zero and one. The index may be taken of the highest probability score in order to determine a predicted word.

Still referring to FIG. 2, decoder may take this output and add it to the decoder inputs. Decoder may continue decoding until a token is predicted. Decoder may stop decoding once it predicts an end token.

Continuing to refer to FIG. 2, in some embodiment, decoder may be stacked N layers high, with each layer taking in inputs from the encoder and layers before it. Stacking layers may allow an LLM to learn to extract and focus on different combinations of attention from its attention heads.

With continued reference to FIG. 2, an LLM may receive an input. Input may include a string of one or more characters. Inputs may additionally include unstructured data. For example, input may include one or more words, a sentence, a paragraph, a thought, a query, and the like. A “query” for the purposes of the disclosure is a string of characters that poses a question. In some embodiments, input may be received from a user device. User device may be any computing device that is used by a user. As non-limiting examples, user device may include desktops, laptops, smartphones, tablets, and the like.

With continued reference to FIG. 2, an LLM may generate at least one annotation as an output. At least one annotation may be any annotation as described herein. In some embodiments, an LLM may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include restrictions, timing, advice, dangers, benefits, and the like.

With continued reference to FIGS. 1 and 2, in some embodiments, orchestrator script 260 may include compute monitor 220, downloading image 216, reverse facial lookup 204, and/or web scraper 224.

### Outputting Results

With continued reference to FIGS. 1 and 2, in some embodiments, final results 244 (e.g., profile results 142) may be sent 148 to a results queue 144. Results queue 144 may include a data queue. In some embodiments, results queue 144 may include an AWS SQS queue. Results queue 144 may be referred to as “Q_Results.” Results queue 144 may be used to store completed analysis results pending delivery to the user. Results queue 144 may contain messages representing finalized outputs generated by the Passive Threat Detection process that have not yet been transmitted to client-facing delivery mechanisms. In some embodiments, each message may include the resulting data set, along with associated metadata such as the user ID, transaction ID, and any relevant processing context. Results queue 144 may enable asynchronous handling of result delivery, ensuring separation between compute-intensive analysis and user notification workflows.

With continued reference to FIGS. 1 and 2, system 100 may be configured to output the results dataset (e.g., final results 244) to the user. In some embodiments, this may include emailing the results to a user. Upon completion of the processing pipeline, system 100 may deliver a copy of the results to the user using email. This may be handled by an Email microservice, which may include a dedicated backend component responsible for generating and transmitting outbound email communications to the user's registered email address. Threat indicators in the results may show whether a cyber presence has been found or not.

With continued reference to FIGS. 1 and 2, results queue 144 may send profile results 142 to a results worker 150. Results worker 150 may include background processing component which continuously monitors and polls results queue 144 for completed result messages. Upon retrieving a message, results worker 150 may update the database with the corresponding transaction and processing log details to maintain an accurate record of result generation and delivery status. Results worker 150 may then forward the results to downstream delivery channels, including a results email service and a real-time WebSocket communication layer. This may enable both asynchronous (email-based) and immediate (WebSocket-based) delivery of results to the user, ensuring timely and reliable access to the processed data.

With continued reference to FIGS. 1 and 2, upon completion of the processing results worker 150 may send profile results 142 to client in real time using a results WebSocket 152 including a WebSocket connection. This may include opening a WebSocket connection 154. Unlike traditional HTTP requests, the WebSocket protocol may maintain a persistent, bidirectional communication channel between the server and the user's browser, allowing results to be pushed directly to the results page as soon as they are available; without requiring the client to poll or refresh. After the results have been transmitted to the client, then WebSocket connection may be closed 156. This may allow for real-time alerts. In some embodiments, profile results 142 may be sent from results worker 150 to database 158.

The following represent non-limiting examples, of possible use cases for system 100.

### 1. Private Investigators

System 100 gives investigators a powerful starting point when traditional identifying information is unavailable. By uploading a single photograph, investigators can quickly resolve an unknown individual into a verified identity complete with name, address, online presence, employment history, and public records.

### Example 1

A PI is hired to locate a person of interest, but the client only has a single photograph; no name, no address, no contact information. The investigator uploads the photo to system 100 and within minutes has a resolved identity including the subject's name, age, residency, social media handles, and employment history, providing a complete starting point without days of manual legwork.

### Example 2

An investigator working a case has security camera footage of a suspect but no identifying information. They extract a still frame and run it through system 100, which matches the face to online profiles and public records, returning the suspect's real name, known aliases, and criminal history to move the case forward.

### 2. Dating & Romantic Safety

System 100 allows individuals to verify a potential date's identity before meeting in person. By cross-referencing a photo against social media profiles and public records, users can confirm whether someone's stated name, age, and background are consistent, and detect warning signs before any meeting takes place.

### Example 1

After matching with someone on a dating app, a user wants to verify they are who they claim to be before meeting in person. System 100 cross-references their profile photo against social media and public records, confirming whether the person's name, age, and details align with what they shared.

### Example 2

A friend is communicating with someone online who seems too good to be true. System 100 scans the photo across the web to reveal whether the image belongs to someone else entirely or is linked to known catfishing or fraud activity.

### 3. Childcare & Caregiver Vetting

When entrusting someone with the care of a child or elderly family member, system 100 provides an independent layer of verification beyond what agencies or references can offer. Users can surface a caregiver's full digital footprint, public records, and identity history to make more informed hiring decisions.

### Example 1

A family hiring a nanny through an agency wants to verify the candidate's background independently. System 100 takes the caregiver's photo and surfaces their full digital footprint and public records, providing a layer of verification outside the agency's screening alone.

### Example 2

An adult child wants to verify the identity and background of a new home assigned to care for their elderly parent. System 100 confirms the individual's identity and surfaces any public criminal history or records of concern before the arrangement continues.

### 4. Online Marketplace Transactions

Meeting strangers through online marketplaces carries inherent risk. System 100 allows buyers and renters to verify the real identity of sellers and landlords before any in-person meeting or financial transaction, reducing the risk of fraud or personal harm.

### Example 1

A buyer is purchasing a vehicle through Facebook Marketplace and the seller wants to meet in person. System 100 identifies the seller from their profile photo, returning their real name, linked accounts, and public records so the buyer can enter the meeting informed.

### Example 2

Someone is renting a room through a classifieds platform and the landlord has only provided a first name and a photo. System 100 matches that photo to verified online profiles and public data, confirming whether the person is legitimate before any payment is made.

### 5. Child Safety & Parenting

Parents can use system 100 to independently verify the backgrounds of adults in their child's environment, including the parents of friends, coaches, or others their child regularly interacts with. This provides an additional layer of assurance before placing a child in an unfamiliar setting.

### Example 1

A parent's child is invited to a sleepover at a new friend's house, and the parent wants to verify the hosting family before allowing the visit. System 100 surfaces the other parent's background, including any criminal history or registered offenses, so the decision can be made with full information.

### Example 2

A parent notices their child has been spending time with an adult neighbor they have not personally met. System 100 allows the parent to verify the individual's identity and review any publicly available records before the relationship continues.

### 6. Roommate Screening

Before sharing a living space with a stranger, system 100 allows prospective tenants and landlords to verify an individual's real identity, review their online presence, and check public records, providing confidence beyond a simple background check request.

### Example 1

Someone responds to a roommate listing and the poster wants to verify their identity beyond what was shared in the application. System 100 takes the prospective roommate's photo and reveals their real name, social media presence, and public records before a key is handed over.

### Example 2

A person moving into a shared house wants to verify the existing tenants before signing the lease. System 100 allows them to run photos of current housemates to surface any criminal records or concerning history in advance.

### 7. Professional & Business Vetting

System 100 helps individuals and businesses verify the identity and track record of contractors, vendors, and potential business partners. By surfacing public records, licensing history, and digital presence, users can confirm that the person they are dealing with is who they claim to be.

### Example 1

A homeowner is hiring a contractor for a renovation and wants to confirm the individual's identity and check for complaints or legal issues. System 100 surfaces their real name, licensing history, and any public legal records tied to their identity before work begins.

### Example 2

A prospective business partner is pitching a new deal and the other party wants to verify their background before signing anything. System 100 pulls up their full digital footprint, past ventures, public filings, and online presence, to confirm whether their track record matches the pitch.

### 8. Romance Scam Detection

Romance scams often rely on stolen photos and fabricated identities to build false trust over time. System 100 can trace a photo across the web to determine whether it belongs to the person using it or has been lifted from another source, exposing fraud before emotional or financial harm occurs.

### Example 1

A family member has been communicating with someone on a dating app who is already requesting money. A relative runs the photo through system 100, which traces the image across the web and reveals it belongs to a completely different person, exposing the scam before any funds are transferred.

### Example 2

A user in a long-distance relationship wants to confirm that their contact's photos are linked to a real and consistent online identity. System 100 maps the image to associated profiles and public records, revealing whether the person has a legitimate digital presence or a fabricated one.

### 9. Personal Safety & Threat Assessment

When someone feels threatened by an unknown individual, system 100 can transform a single photo into actionable identifying information. This gives individuals the information they need to report a situation to law enforcement or take informed protective measures.

### Example 1

An individual has been repeatedly approached at their workplace by an unknown person, and security footage captured their face. System 100 matches the image against online profiles and public records, returning a name and background that can be provided directly to law enforcement.

### Example 2

A person receives unwanted messages from an anonymous social media account using only a profile photo. System 100 identifies the real individual behind the image, providing the information needed to pursue a formal complaint or protective action.

### 10. Fraud & Identity Verification

System 100 helps individuals quickly verify whether a person claiming a specific identity or affiliation is who they say they are. In situations where impersonation could lead to financial loss, theft, or personal harm, a rapid identity check can prevent serious consequences.

### Example 1

Someone claiming to be a utility company representative arrives at a home unannounced. The homeowner captures a photo and runs it through system 100, which checks whether the face matches any verifiable identity associated with the company, exposing the impersonator before they are granted access.

### Example 2

A user receives a social media friend request from someone claiming to be an old classmate, but the profile looks inconsistent. System 100 reveals whether the photo is genuinely linked to the person they claim to be or belongs to someone else entirely, stopping a social engineering attempt before trust is established.

### Microservice Architecture

Referring now to FIG. 7, an exemplary embodiment of a gateway and microservice architecture 700 is shown. This architecture may employ an API Gateway as the central intermediary between the client and the system's internal microservices. Rather than exposing each service directly to the client, the gateway serves as a single, unified entry point that encapsulates the underlying system architecture, shielding the client from the complexity of the distributed backend. This pattern may enable the centralized enforcement of cross-cutting concerns such as request validation, authentication, routing, and response transformation, ensuring that these responsibilities are handled consistently and uniformly without burdening individual services. Without this architectural layer, clients may be required to communicate directly with each microservice, resulting in tighter coupling, increased client-side complexity, and a more fragile system boundary.

With continued reference to FIG. 7, APIs used throughout this disclosure (e.g., in system 100) may include identity resolution APIs. Identity resolution APIs may include inverse facial recognition search which may take a face image and returns all URLs where matching faces appear across the public web. Identity resolution APIs may include automated web scraping and data extraction which may crawl returned URLs and serializes full page content into structured JSON. APIs used throughout this disclosure (e.g., in system 100) may include public records & background check APIs. Public records & background check APIs may include nationwide sex offender registry APIs which may search by name, DOB, city, state, ZIP, geospatial parameters, and facial recognition matching. Public records & background check APIs may include criminal records database APIs which may query federal, state, and local criminal history databases for arrests, convictions, and court records. Public records & background check APIs may include Court records and civil litigation APIs which may search public court filings, lawsuits, judgments, liens, and bankruptcy records. Public records & background check APIs may include warrant and law enforcement database APIs which may check for active and historical warrants across jurisdictions. APIs used throughout this disclosure (e.g., in system 100) may include people search & contact APIs. People search & contact APIs may include people search and public records API which may pull address history, phone numbers, email addresses, known associates, and relatives from public data sources. People search & contact APIs may include address and residency APIs which may confirm current and historical addresses tied to a resolved identity. People search & contact APIs may include employment and professional license APIs which may check employer records, professional licensing databases, and business registrations. People search & contact APIs may include social media profile discovery APIs which may identify linked social media accounts across platforms based on name, email, username, or image matching. People search & contact APIs may include dating profile detection API which may search dating platforms for profiles associated with the resolved identity or image. People search & contact APIs may include username and alias correlation APIs which may cross-reference usernames across multiple platforms to map a subject's full digital footprint. APIs used throughout this disclosure (e.g., in system 100) may include verification & fraud prevention APIs. Verification & fraud prevention APIs may include AI image detection APIs which may analyze uploaded photos to determine whether they are AI-generated, deepfaked, or manipulated. Verification & fraud prevention APIs may include identity fraud and scam database which may check resolved identities against known fraud rings, romance scam databases, and catfish registries. Verification & fraud prevention APIs may include email and phone reputation APIs which may score the risk level of email addresses and phone numbers associated with the resolved identity.

### Exemplary User Interfaces

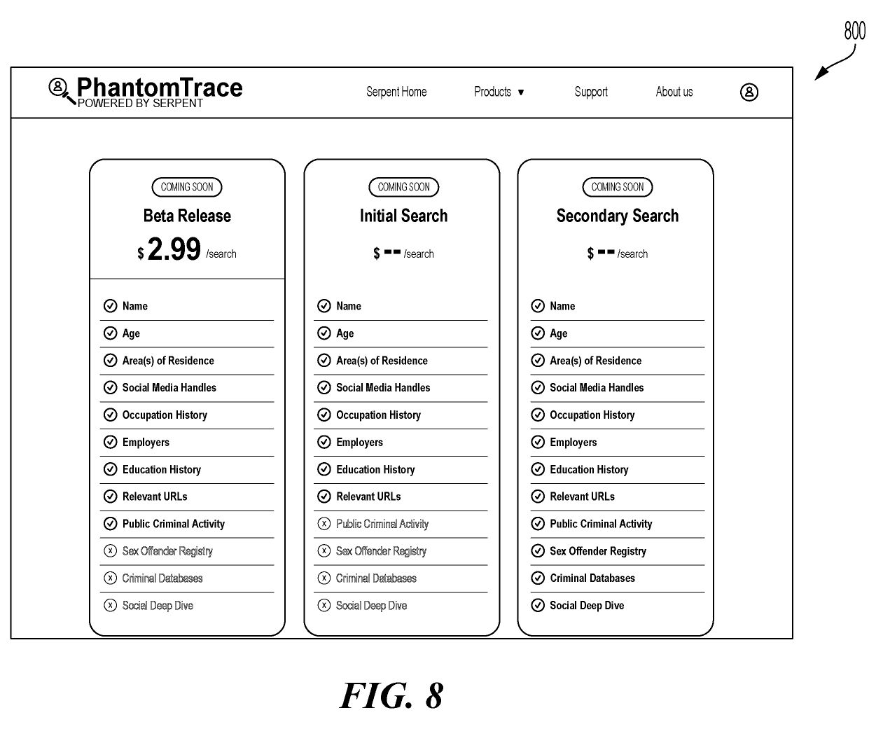

Referring now to FIGS. 8-13D show various user interfaces for system 100.

Referring to FIG. 8, a search tier display 800 is shown. Search tier display 800 may be displayed to users to show the different search tiers (e.g., standard or advanced) that are available, as well as the features that are included (or not included) in the different tiers.

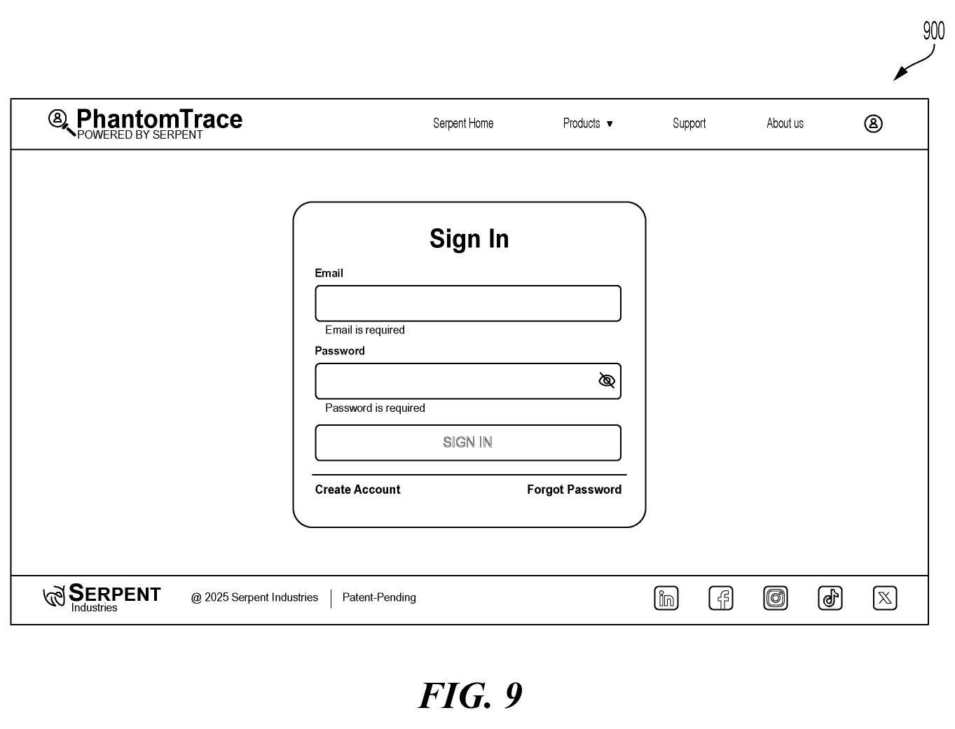

Referring to FIG. 9, a log-in interface 900 is shown. Log-in interface may be presented to a user as part of log in 104. For example, Log-in interface 900 may allow a user to enter a user identifier, such as, as non-limiting examples, a username, an email, or the like. Log-in interface 900 may allow a user to enter a password, pin, or other passcode. Log-in interface 900 may support biometric log-ins such as fingerprint or facial scans.

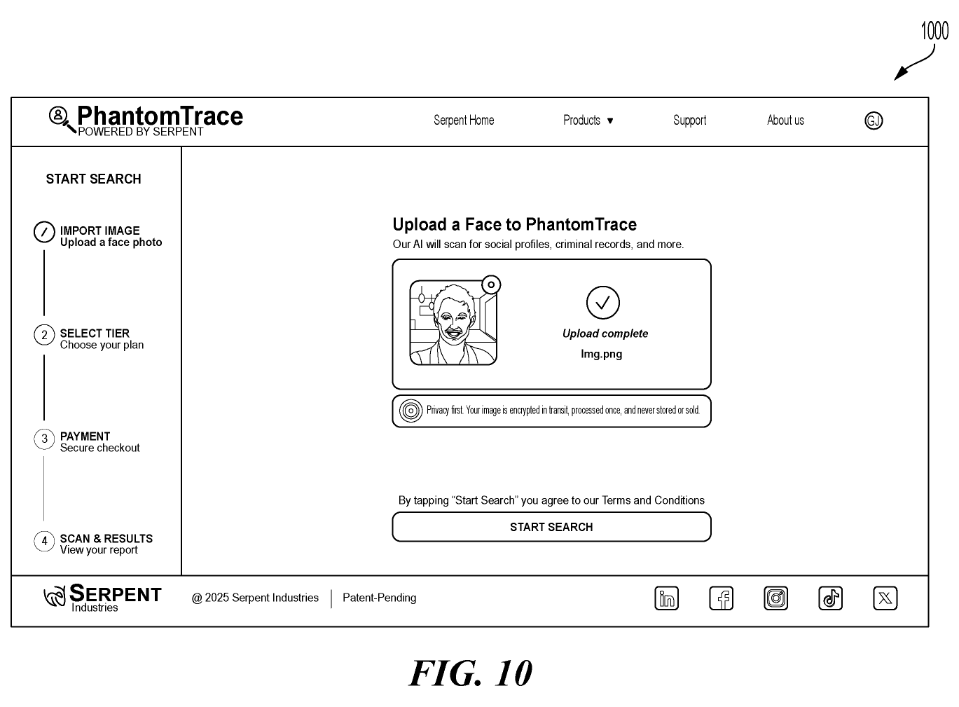

Referring to FIG. 10, an image upload interface 1000 is shown. Image upload interface 1000 may be presented to a user as part of uploading uploaded image 110. Image upload interface 1000 may include a button or field in which user may specify an image to upload. In some embodiments, image upload interface 1000 may include a “start search button” which a user may click to start a reverse image search.

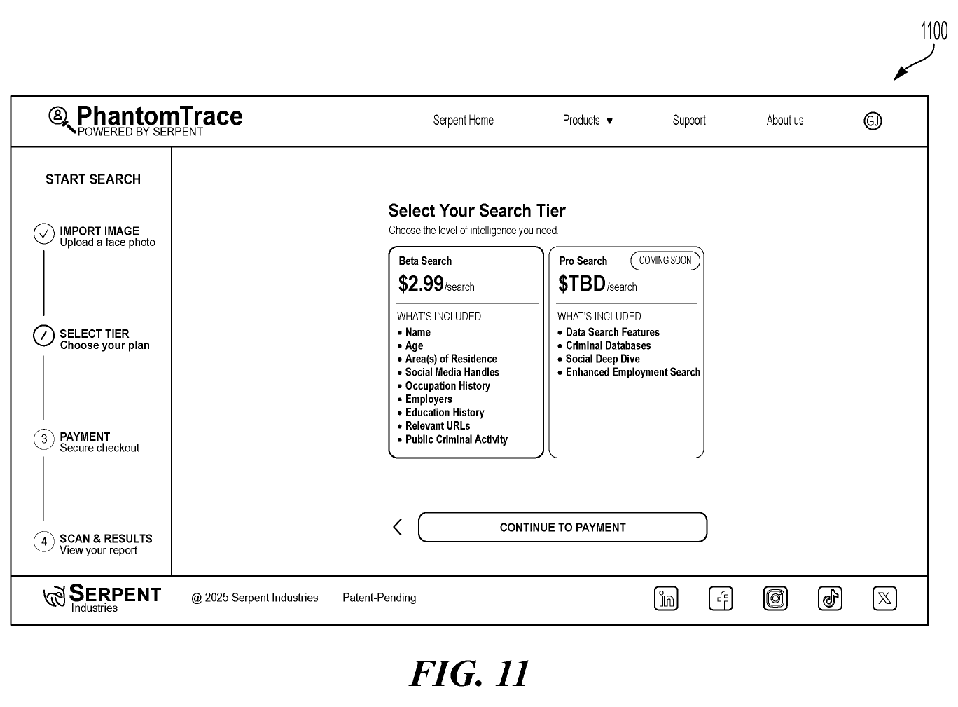

Referring to FIG. 11, a search tier selection interface 1100 is shown. Search tier selection interface 1100 may list a plurality of search tiers. Search tier selection interface 1100 may list features that are included (or not included) in the different tiers. Search tier selection interface 1100 may allow a user to click on or otherwise interact with the different tiers in order to make a selection. Search tier selection interface 1100 may include a cost associated with each tier. Search tier selection interface 1100 may be presented to user as part of selecting product 118.

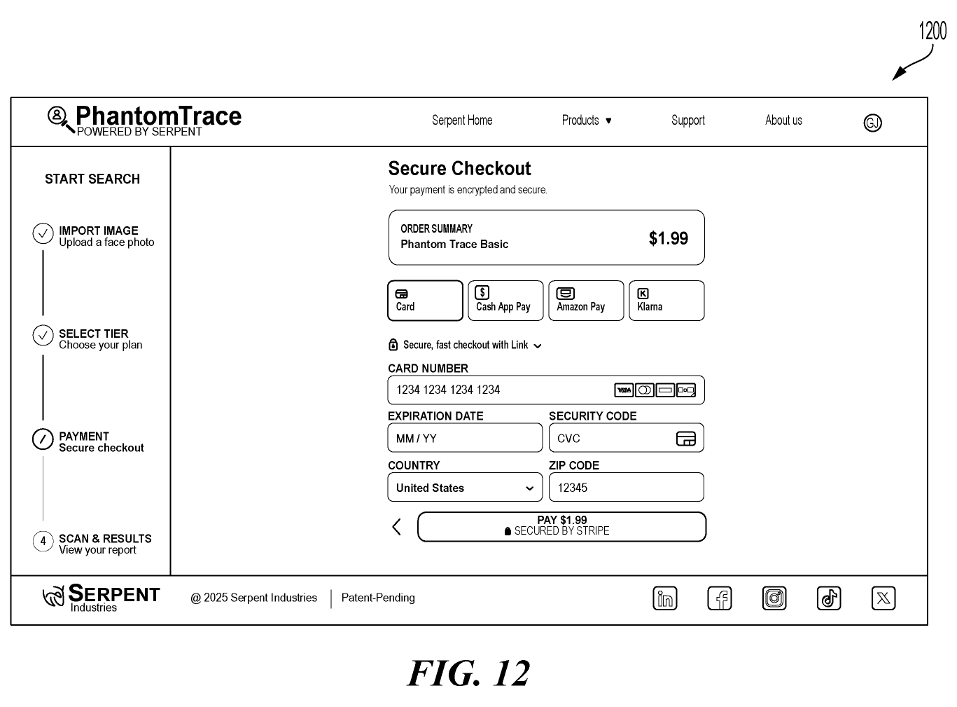

Referring to FIG. 12, a checkout interface 1200 is shown. Checkout interface 1200 may allow a user to enter payment information. Payment information may include a credit card number, expiration date, security code, name, country, zip code, or the like. Checkout interface 1200 may allow a user to select from one or more third-party checkout services. Third-party checkout services may include, as non-limiting examples, SHOPIFY, GOOGLE PAY, APPLE PAY, CASH APP PAY, AMAZON PAY, KLARNA, or the like. Checkout interface 1200 may be presented to a user as part of entering payment details 120. Checkout interface 1200 may include one or more iFrames or embedded features as described throughout this disclosure.

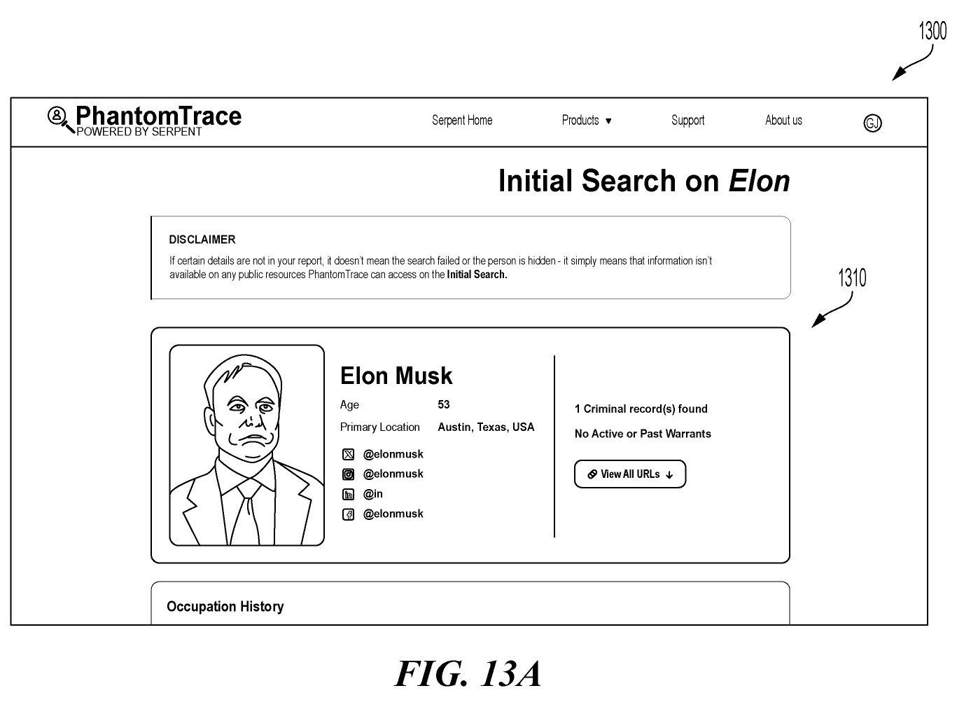

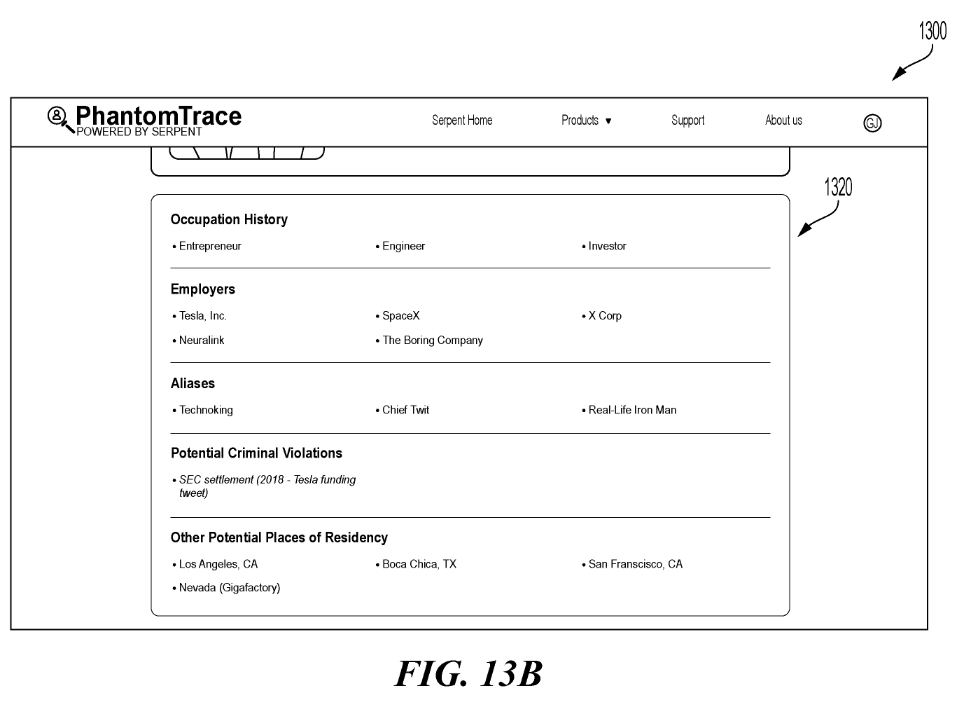

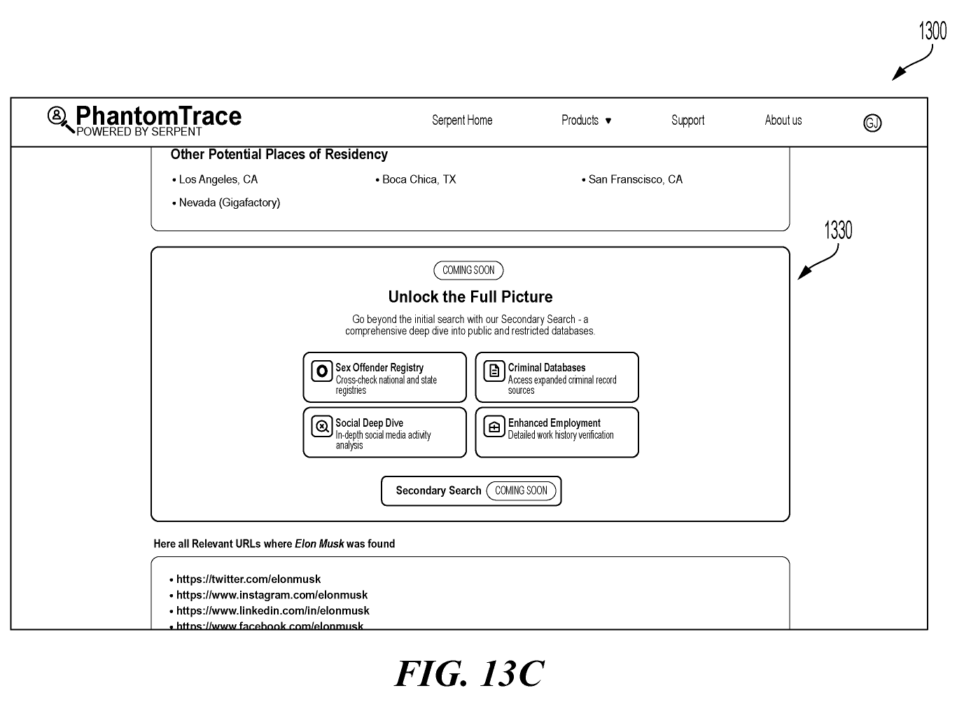

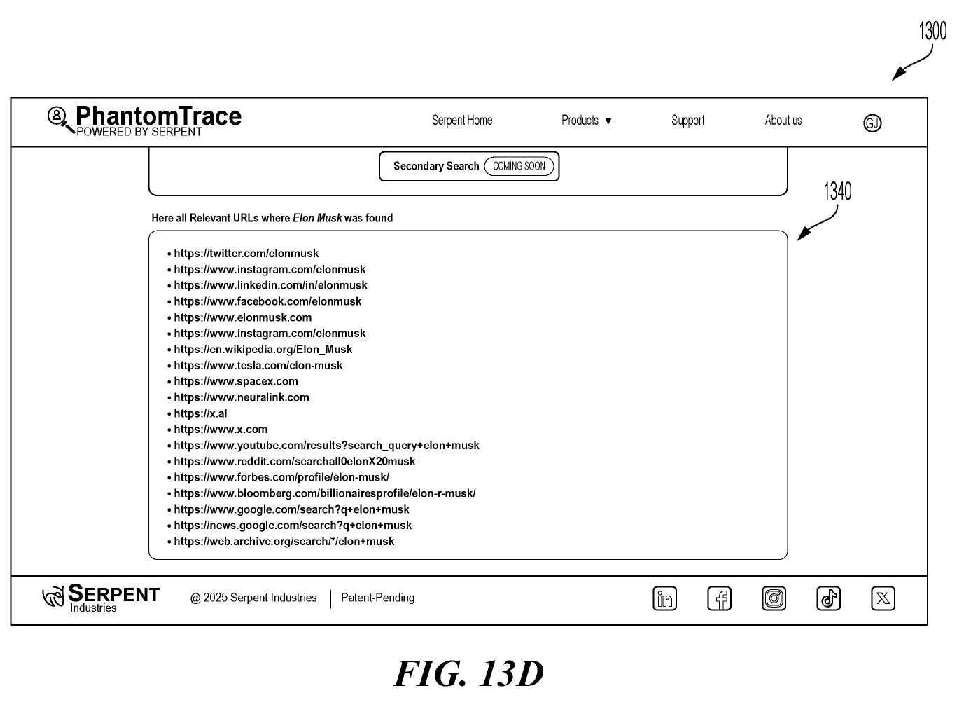

Referring to FIGS. 13A-D, an exemplary results interface 1300 is shown. Exemplary results interface 1300 may include a summary profile 1310. Summary profile 1310 may include a subject’s name, picture, age, social media profiles, location, criminal records, and/or warrants. Exemplary results interface 1300 may include a detailed profile 1320. Detailed profile 1320 may include, as non-limiting examples, occupation history, employers (past or present), aliases, potential criminal violations, and/or other places of residency. Exemplary results interface 1300 may include a widget 1330, wherein widget 1330 may prompt user to conduct a secondary/advanced search (i.e. to purchase a more advanced search tier.) widget 1330 may include a URL list 1340. URL list 1340 may include URLs from set of candidate results 212.

### Email Results

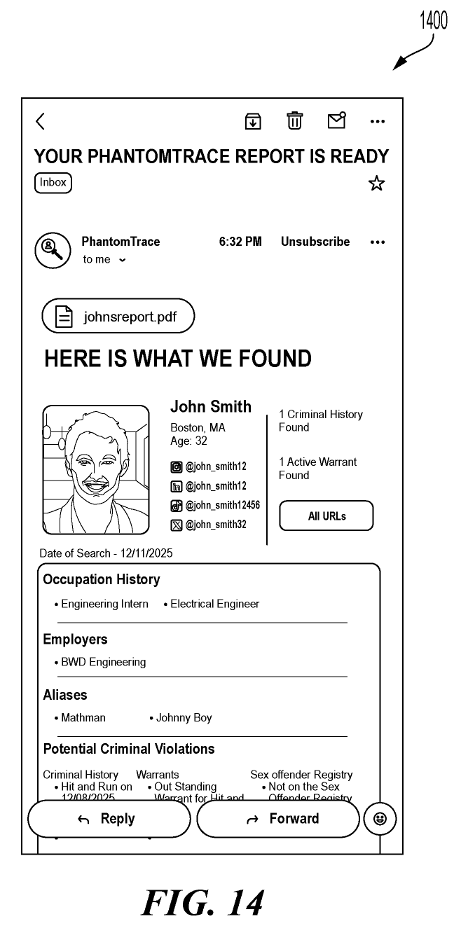

Referring to FIG. 14, an exemplary email report 1400 is shown. Exemplary email report 1400 may be emailed to users as part of or in addition to presenting results to users. Exemplary email report 1400 may include data similar to or the same as that presented in exemplary results interface 1300. Exemplary email report may include data in HTML or may include a report attached as a pdf. Exemplary email report 1400 may include summary profile 1310, detailed profile 1320, widget 1330, and/or URL list 1340 as described further above.

### Exemplary Method for Identity Intelligence

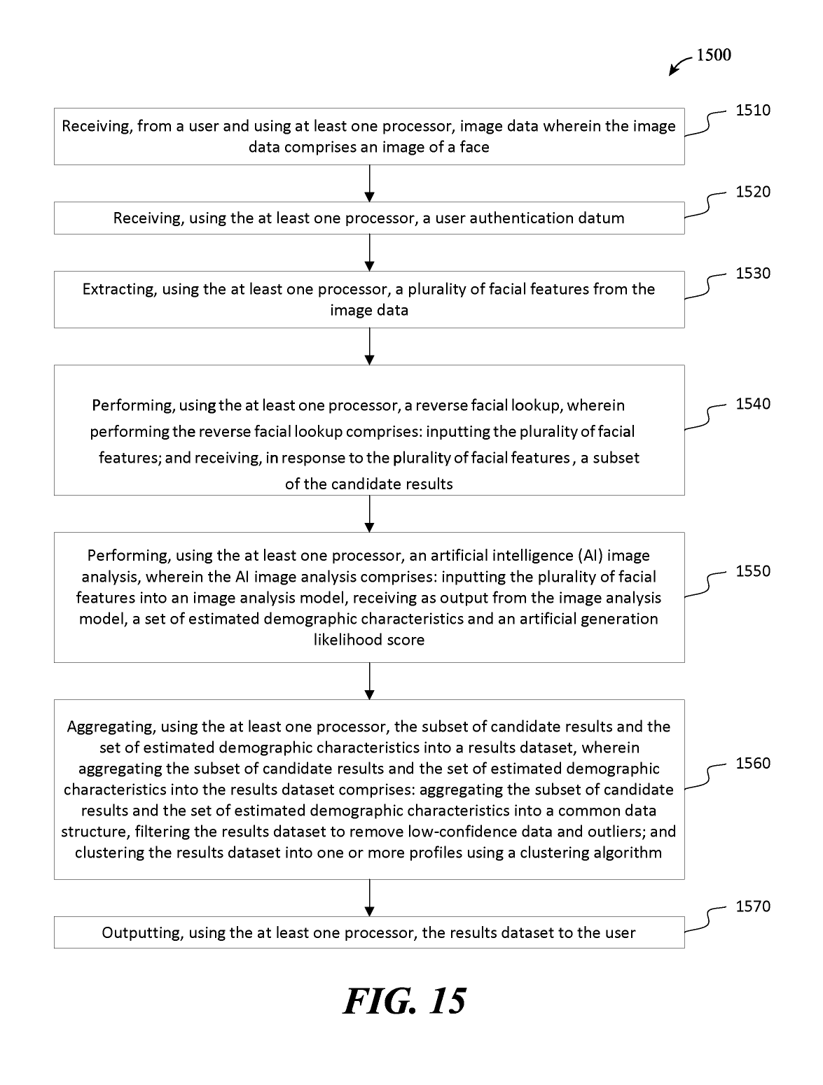

Referring now to FIG. 15, a flow diagram for an exemplary method 1500 for identity intelligence is shown. Exemplary method 1500 may be a computer-implemented method. Exemplary method 1500 may include a step 1510 of receiving, from a user and using at least one processor, image data wherein the image data includes an image of a face. This may be performed, without limitation, as described with reference to any of FIGS. 1-14.

With continued reference to FIG. 15, exemplary method 1500 may include a step 1520 of receiving, using the at least one processor, a user authentication datum. This may be performed, without limitation, as described with reference to any of FIGS. 1-14.

With continued reference to FIG. 15, exemplary method 1500 may include a step 1530 of extracting, using the at least one processor, a plurality of facial features from the image data. This may be performed, without limitation, as described with reference to any of FIGS. 1-14.

With continued reference to FIG. 15, exemplary method 1500 may include a step 1540 of performing, using the at least one processor, a reverse facial lookup, wherein performing the reverse facial lookup comprises: inputting the plurality of facial features; and receiving, in response to the plurality of facial features, a subset of the candidate results. This may be performed, without limitation, as described with reference to any of FIGS. 1-14.

With continued reference to FIG. 15, exemplary method 1500 may include a step 1550 of performing, using the at least one processor, an artificial intelligence (AI) image analysis, wherein the AI image analysis includes: inputting the plurality of facial features into an image analysis model; receiving as output from the image analysis model, a set of estimated demographic characteristics and an artificial generation likelihood score. This may be performed, without limitation, as described with reference to any of FIGS. 1-14.

With continued reference to FIG. 15, exemplary method 1500 may include a step 1560 of aggregating, using the at least one processor, the subset of candidate results and the set of estimated demographic characteristics into a results dataset, wherein aggregating the subset of candidate results and the set of estimated demographic characteristics into the results dataset includes: aggregating the subset of candidate results and the set of estimated demographic characteristics into a common data structure; filtering the results dataset to remove low-confidence data and outliers; and clustering the results dataset into one or more profiles using a clustering algorithm. This may be performed, without limitation, as described with reference to any of FIGS. 1-14.

With continued reference to FIG. 15, exemplary method 1500 may include a step 1570 of outputting, using the at least one processor, the results dataset to the user. This may be performed, without limitation, as described with reference to any of FIGS. 1-14.

In some aspects, the techniques described herein relate to a method, further including preforming, using the at least one processor, an advanced search, wherein performing the advanced search includes determining whether the advanced search has been requested using the user authentication datum and, if the advanced search has been requested: normalizing the one or more profiles; and retrieving query result data by querying a plurality of advanced search application programming interfaces (APIs) using the normalized one or more profiles.

In some aspects, the techniques described herein relate to a method, wherein performing the advanced search further includes integrating the query result data into the results dataset.

In some aspects, the techniques described herein relate to a method, wherein returning the subset of the candidate results as a function of the confidence scores includes receiving uniform resource locators (URLs) associated with the candidate results.

In some aspects, the techniques described herein relate to a method, wherein performing the reverse facial lookup further includes: retrieving scraped data associated with the URLs using a web scraper; and cleaning the scraped data using a dataset cleaner script, wherein the dataset cleaner script is configured to: normalize the scraped data associated with each of the URLs into a consistent internal representation; normalize raw text content of the scraped data; and populate structured candidate fields associated with each of the URLs with ranked lists of likely values for key profile attributes.

In some aspects, the techniques described herein relate to a method, wherein performing the reverse facial lookup further includes: inputting each set of cleaned scraped data into a large language model (LLM); and generating, using the LLM, structured profile attributes associated with a subject.

In some aspects, the techniques described herein relate to a method, wherein the LLM includes an instruction-tuned transformer model, wherein: each inputted set of cleaned scraped data is provided to the LLM as a structured JavaScript Object Notation (JSON) file; and the instruction-tuned transformer model is constrained to produce strictly formatted JSON outputs with predefined fields.

In some aspects, the techniques described herein relate to a method, further including performing, using the at least one processor, a reverse name search, wherein the reverse name search includes: normalizing name data; constructing a plurality of API queries using the name data; and retrieving records associated with the name data using the plurality of API queries and a plurality of APIs.

In some aspects, the techniques described herein relate to a method, further including: determining, using the at least one processor, whether name data has been received from the user; conduct the reverse name search if the name data has been received; and skip the reverse name search if the name data has not been received.

In some aspects, the techniques described herein relate to a method, further including: monitoring, using the at least one processor, compute availability using a compute monitor; and dispatching, using the at least one processor, the image data for image processing as a function of determining, by the compute monitor, that there is compute availability.

In some aspects, the techniques described herein relate to a method, further including wherein performing the reverse facial lookup includes: comparing the plurality of facial features to a plurality of candidate results; determining confidence scores as a function of comparing the plurality of facial features to the plurality of candidate results; and returning a subset of the candidate results as a function of the confidence scores.

### Exemplary Machine Learning Model and Neural Network

Referring now to FIG. 16, an exemplary embodiment of a machine-learning module 1600 is shown. Machine-learning module 1600 may be configured to perform one or more machine learning processes as described throughout this disclosure. Machine-learning module 1600 may perform determinations, classification, and/or analysis steps, methods, processes, or the like as described in this disclosure using machine learning processes. A “machine learning process,” as used in this disclosure, is a process that automatedly uses training data 1605 to generate one or more machine-learning models 1610.

With continued reference to FIG. 16, for the purposes of this disclosure, “training data” is data that contains correlations that a machine-learning process may use to model relationships between two or more types of data. For example, training data 1605 may include one or more training examples. Multiple data entries in training data 1605 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. In some embodiments, training data 1605 may include input training data correlated to output training data. Input training data may include, as a non-limiting example scraped data as described further throughout this disclosure. Output training data may include, as a non-limiting example extracted features as described further throughout this disclosure. Elements in training data 1605 may be linked to descriptors of categories by tags, tokens, or other data elements; for instance, and without limitation, training data 1605 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

With continued reference to FIG. 16, in some embodiments, training data 1605 may be divided into different formats, categories, and/or groups. For example, in some embodiments, training data 1605 may be divided into one or more cohorts, categorizations, time periods, data sources, and the like. In some embodiments, training data 1605 may be assigned to categories using a classifier; as a non-limiting example, a training data classifier. Training data classifier may include a machine-learning module as described elsewhere with respect to FIG. 16. For example, in some embodiments, training data 1605 may be input into training data classifier and training data classifier may output a classification. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 1600 may generate a classifier using a classification algorithm, defined as a processes whereby a computing device and/or any module and/or component operating thereon derives a classifier from training data 1605. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher’s linear discriminant, quadratic classifiers, decision trees, boosted trees, random forest classifiers, learning vector quantization, and/or neural network-based classifiers. In some embodiments, training data 1605 may be classified into one or more categories such as demographics, sex, age, ethnicity, race, or the like.

With continued reference to FIG. 16, training data 1605 may be retrieved, in some embodiments, from a data structure 1615. A data structure 1615 may be remote to a computing device and communicative with a computing device by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local servers or personal computers. A “mesh network” as used in this disclosure is a local network topology in which the infrastructure a computing device connect directly, dynamically, and non-hierarchically to as many other computing devices as possible. A “network topology” as used in this disclosure is an arrangement of elements of a communication network. data structure 1615 may be implemented, without limitation, as a relational database, a key-value retrieval database such as a NOSQL database, or any other format or structure for use as a database that a person skilled in the art would recognize as suitable upon review of the entirety of this disclosure. data structure 1615 may alternatively or additionally be implemented using a distributed data storage protocol and/or data structure, such as a distributed hash table or the like. data structure 1615 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In an embodiment, data structure 1615 may be a generic storage mechanism. A generic storage mechanism may be a storage system or method that is not specific to any particular type or format of data, that is, a storage solution that provides a flexible and adaptable way to store and retrieve data without being tied to a specific data format, schema, or domain. In some embodiments, training data 1605 may be stored in data structure 1615. In some embodiments, training data 1605 may be retrieved from data structure 1615.

With continued reference to FIG. 16, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

With continued reference to FIG. 16, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

With continued reference to FIG. 16, a “machine-learning model,” as used in this disclosure, is a data structure representing and/or instantiating a mathematical and/or algorithmic representation of a relationship between inputs and outputs as generated using any machine-learning process. For example, machine-learning process may include, without limitation, any machine-learning process described in this disclosure.

With continued reference to FIG. 16, machine-learning process may include an unsupervised machine-learning process 1620. An unsupervised machine-learning process, as used herein, is a process that derives inferences in datasets without regard to labels; as a result, an unsupervised machine-learning process may be free to discover any structure, relationship, and/or correlation provided in the data. Unsupervised processes machine-learning process 1620 may not require a response variable; unsupervised processes machine-learning process 1620 may be used to find interesting patterns and/or inferences between variables, to determine a degree of correlation between two or more variables, or the like.

With continued reference to FIG. 16, machine-learning process may include a supervised machine-learning process 1625. Supervised machine-learning process 1625 may use training data 1605 with both exemplary inputs and expected outputs and use that training data 1605 to train a machine-learning model 1610. For example, during a training process, machine learning process may evaluate an actual output generated by machine-learning model 1610 and compare it to an expected output from training data 1605. Based on the difference between the actual and expected outputs, one or more weights within machine-learning model 1610 may be updated. For example, in some cases a scoring function may be used to train machine-learning model 1610. Scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1605.

With continued reference to FIG. 16, machine-learning process may include a lazy-learning process 1630. Lazy learning is a machine-learning approach in which the model delays generalization until a query is made. For example, this can be rather than learning a global model during training. Instead of building an abstract representation of the data up front, a lazy learner may store the training instances and wait until it needs to make a prediction. For example, when a new input arrives, the system may perform computation on the fly. Because no heavy training occurs in advance, lazy-learning algorithms may be fast to set up but can be computationally expensive at prediction time and often require storing large datasets in memory. An example may include k-nearest neighbors (k-NN), which classifies new points based on the labels of their closest neighbors in the stored data. Lazy learning may adapt naturally to new data because the “model” is effectively the dataset itself, but this also means it can be sensitive to noise and may not scale well with very large datasets.

With continued reference to FIG. 16, in some embodiments, machine-learning module 1600 may receive external feedback 1635. External feedback 1635 may include, as a non-limiting example, feedback received from a user. In some embodiments, external feedback 1635 may be received through a user interface (such as, for example, a graphical user interface (GUI).

With continued reference to FIG. 16, machine-learning module 1600 may be configured to re-train machine-learning model 1610. In some embodiments, re-training machine-learning model 1610 may include re-training machine-learning model 1610 as a function of external feedback 1635. In some embodiments, external feedback 1635 may serve as a source of labeled or partially labeled data that reflects how the model performs in real-world conditions. For example, if a user provides negative external feedback 1635, then the set of data from training data 1605 may be assigned a negative label. In some embodiments, external feedback 1635 may include users correcting an output 1640 of machine-learning model 1610—such as flagging an incorrect prediction, choosing a preferred recommendation, or providing explicit labels. These interactions can be collected and added back into the training dataset. Over time, this additional data may help the model adapt to new patterns, correct systematic errors, and better align with user expectations. The re-training process may include cleaning and validating external feedback 1635, merging it with existing datasets such as training data 1605, and/or periodically running a new training cycle to update model parameters.

With continued reference to FIG. 16, machine-learning module 1600 may be configured to validate machine-learning model 1610. In some embodiments, machine-learning module 1600 may validate machine-learning model 1610 using validation data 1645. Validation data 1645 may be a subset of data used to train machine-learning model 1605. For example, validation data 1645 may include a subset of training data 1605. In some embodiments, validation data 1645 may include a percentage of training data 1605. As non-limiting example, validation data 1645 may include 1%,2%, 5%, 10%, 20%, 30%, and the like of training data 1605. In some embodiments, machine-learning model 1610 may not be exposed to validation data 1645 during training. Validation data 1645 may acts as a checkpoint that helps determine whether the model is generalizing well or simply memorizing training data 1605. As the model learns, its performance on the validation set may be monitored to guide decisions such as choosing hyperparameters, selecting architectures, adjusting regularization strength, or determining when to stop training to avoid overfitting.

With continued reference to FIG. 16, machine-learning model 1610 may be configured to receive one or more inputs 1650 and generate, as a function of the one or more inputs 1650, one or more outputs 1640. Outputs 1640 may be presented to users for example trough user interfaces and/or GUIs. In some embodiments, external feedback 1635 may be received users as a function of output 1640.

With continued reference to FIG. 16, one or more, processes, machine-learning processes, actions, steps, or the like as disclosed above may be performed using dedicated hardware 1655. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware 1655 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware 1655 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware 1655 to perform one or more operations described herein, such as evaluation of model and/or algorithm outputs, one-time or iterative updates to parameters, coefficients, weights, and/or biases, and/or any other operations such as vector and/or matrix operations as described in this disclosure.

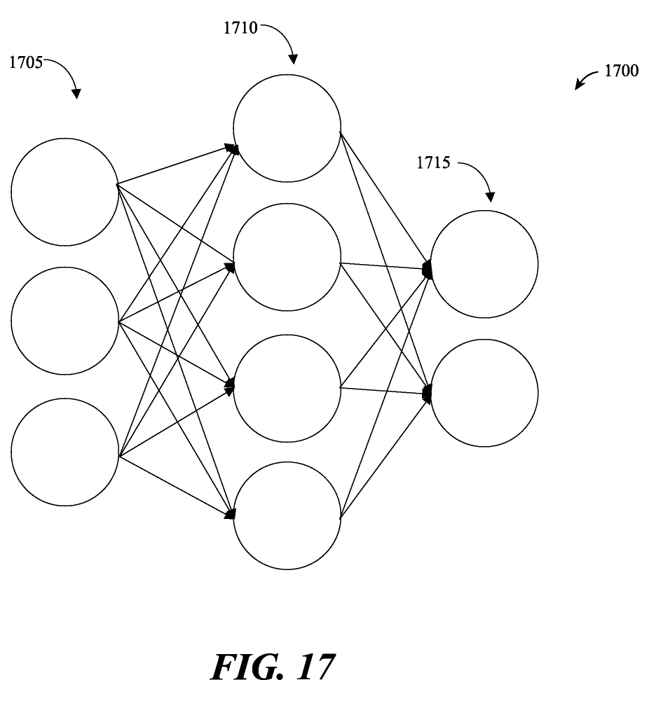

Referring now to FIG. 17, an exemplary embodiment of neural network 1700 is illustrated. A neural network 1700 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 1705, one or more intermediate layers 1710, and an output layer of nodes 1715. Connections between nodes may be created using a process of "training" the network, in which elements from a training dataset may applied to the input nodes. A suitable training algorithm (such as Levenberg-Marquardt, conjugate gradient, simulated annealing, or other algorithms) may then be used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

### Exemplary Computing Device in the Exemplary Form of a Computer System

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 18 shows a diagrammatic representation of one embodiment of a computing device in the exemplary form of a computer system 1800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1800 includes a processor 1805 and a memory 1810 that communicate with each other, and with other components, via a bus 1815. Bus 1815 may include any of several types of bus structures including, but not limited to, a memory bus, a memory controller, a peripheral bus, a local bus, and any combinations thereof, using any of a variety of bus architectures.

Processor 1805 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1805 may be organized according to Von Neumann and/or Harvard architecture as a non-limiting example. Processor 1805 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo’s algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 1810 may include various components (e.g., machine-readable media) including, but not limited to, a random-access memory component, a read only component, and any combinations thereof. In one example, a basic input/output system 1820 (BIOS), including basic routines that help to transfer information between elements within computer system 1800, such as during start-up, may be stored in memory 1810. Memory 1810 may also include (e.g., stored on one or more machine-readable media) instructions (e.g., software) 1825 embodying any one or more of the aspects and/or methodologies of the present disclosure. In another example, memory 1810 may further include any number of program modules including, but not limited to, an operating system, one or more application programs, other program modules, program data, and any combinations thereof. Memory 1810 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 1800 may also include a storage device 1830. Examples of a storage device (e.g., storage device 1830) include, but are not limited to, a hard disk drive, a magnetic disk drive, an optical disc drive in combination with an optical medium, a solid-state memory device, and any combinations thereof. Storage device 1830 may be connected to bus 1815 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1830 (or one or more components thereof) may be removably interfaced with computer system 1800 (e.g., via an external port connector (not shown)). Particularly, storage device 1830 and an associated machine-readable medium may provide nonvolatile and/or volatile storage of machine-readable instructions, data structures, program modules, and/or other data for computer system 1800. In some embodiments, storage device 1830 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 1825) may reside, completely or partially, within machine-readable medium . In another example, software may reside, completely or partially, within processor 1805.

Computer system 1800 may also include an input device 1840. In one example, a user of computer system 1800 may enter commands and/or other information into computer system 1800 via input device 1840. Examples of an input device 1840 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1840 may be interfaced to bus 1815 via any of a variety of interfaces (not shown) including, but not limited to, a serial interface, a parallel interface, a game port, a USB interface, a FIREWIRE interface, a direct interface to bus 1815, and any combinations thereof. Input device 1840 may include a touch screen interface that may be a part of or separate from display 1845, discussed further below. Input device 1840 may be utilized as a user selection device for selecting one or more graphical representations in a graphical interface as described above.

A user may also input commands and/or other information to computer system 1800 via storage device 1830 (e.g., a removable disk drive, a flash drive, etc.) and/or network interface device 1850. A network interface device, such as network interface device 1850, may be utilized for connecting computer system 1800 to one or more of a variety of networks, such as network 1855, and one or more remote devices 1860 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data neitwork associated with a telephone/voice provider (e.g., a mobile communications provider data and/or voice network), a direct connection between two computing devices, and any combinations thereof. A network, such as network 1855, may employ a wired and/or a wireless mode of communication. In general, any network topology may be used. Information (e.g., data, software, etc.) may be communicated to and/or from computer system 1800 via network interface device 1850.

Computer system 1800 may further include a video display adapter 1865 for communicating a displayable image to a display device, such as display 1845. Examples of a display device include, but are not limited to, a liquid crystal display (LCD), a cathode ray tube (CRT), a plasma display, a light emitting diode (LED) display, and any combinations thereof. Display adapter 1865 and display 1845 may be utilized in combination with processor 1805 to provide graphical representations of aspects of the present disclosure. In addition to a display device, computer system 1800 may include one or more other peripheral output devices including, but not limited to, an audio speaker, a printer, and any combinations thereof. Such peripheral output devices may be connected to bus 1815 via a peripheral interface 1870. Examples of a peripheral interface include, but are not limited to, a serial port, a USB connection, a FIREWIRE connection, a parallel connection, and any combinations thereof.

Further referring to FIG. 18, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 18, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 18, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 1800, processor 1805, and memory 1810 may be virtualized; that is, a virtual machine and/or container may interact directly with such computing system 1800, processor 1805, and/or memory 1810, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 1805 comprises a plurality of processors and/or processor cores, virtualization may, in some cases, simulate or emulate a single (virtual) processor whose functions are allocated to one or more of the plurality of processors and/or processor cores. In this case, while processor 1805 may be said to be virtualized, the processor 1805, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Those skilled in the art, after having read the entirety of this disclosure, will recognize, or be able to ascertain using no more than routine experimentation, numerous equivalents to the specific procedures, embodiments, claims, and examples described herein. Such equivalents were considered to be within the scope of this invention and covered by the claims appended hereto. For example, as discussed above, it should be understood that the particular methods and systems used to implement the disclosure may be modified without changing the spirit, and as such the various art-recognized alternatives are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A system for identity intelligence, the system comprising:
at least one processor; and
a memory communicatively connected to the at least one processor, wherein the memory contains instructions configuring the at least one processor to:
receive, from a user, image data wherein the image data comprises an image of a face;
receive a user authentication datum;
extract a plurality of facial features from the image data;
perform a reverse facial lookup, wherein performing the reverse facial lookup comprises:
inputting the plurality of facial features; and
receiving, in response to the plurality of facial features, a subset of the candidate results;
perform an image analysis, wherein the image analysis comprises:
inputting the plurality of facial features into an image analysis model; and
receiving as output from the image analysis model, a set of estimated demographic characteristics and an artificial generation likelihood score;
aggregate the subset of candidate results and the set of estimated demographic characteristics into a results dataset, wherein aggregating the subset of candidate results and the set of estimated demographic characteristics into the results dataset comprises:
aggregating the subset of candidate results and the set of estimated demographic characteristics into a common data structure;
filtering the results dataset to remove low-confidence data and outliers; and
clustering the results dataset into one or more profiles using a clustering algorithm; and
output the results dataset to the user.

2. The system of claim 1, wherein the memory contains instructions further configuring the at least one processor to preform an advanced search, wherein performing the advanced search comprises determining whether the advanced search has been requested using the user authentication datum and, if the advanced search has been requested:
normalizing the one or more profiles; and
retrieving query result data by querying a plurality of advanced search application programming interfaces (APIs) using the normalized one or more profiles.

3. The system of claim 2, wherein performing the advanced search further comprises integrating the query result data into the results dataset.

4. The system of claim 1, wherein returning the subset of the candidate results as a function of the confidence scores comprises receiving uniform resource locators (URLs) associated with the candidate results.

5. The system of claim 4, wherein performing the reverse facial lookup further comprises:
retrieving scraped data associated with the URLs using a web scraper; and
cleaning the scraped data using a dataset cleaner script, wherein the dataset cleaner script is configured to:
normalize the scraped data associated with each of the URLs into a consistent internal representation;
normalize raw text content of the scraped data; and
populate structured candidate fields associated with each of the URLs with ranked lists of likely values for key profile attributes.

6. The system of claim 5, wherein performing the reverse facial lookup further comprises:
inputting each set of cleaned scraped data into a large language model (LLM); and
generating, using the LLM, structured profile attributes associated with a subject.

7. The system of claim 6, wherein the LLM comprises an instruction-tuned transformer model, wherein:
each inputted set of cleaned scraped data is provided to the LLM as a structured JavaScript Object Notation (JSON) file; and
the instruction-tuned transformer model is constrained to produce strictly formatted JSON outputs with predefined fields.

8. The system of claim 1, wherein the memory contains instructions further configuring the at least one processor to perform a reverse name search, wherein the reverse name search comprises:
normalizing name data;
constructing a plurality of API queries using the name data; and
retrieving records associated with the name data using the plurality of API queries and a plurality of APIs.

9. The system of claim 8, wherein the memory contains instructions further configuring the at least one processor to:
determine whether name data has been received from the user;
conduct the reverse name search if the name data has been received; and
skip the reverse name search if the name data has not been received.

10. The system of claim 1, wherein the memory contains instructions further configuring the at least one processor to:
monitor compute availability using a compute monitor; and
dispatch the image data for image processing as a function of determining, by the compute monitor, that there is compute availability.

11. The system of claim 1, wherein performing the reverse facial lookup further comprises:
comparing the plurality of facial features to a plurality of candidate results;
determining confidence scores as a function of comparing the plurality of facial features to the plurality of candidate results; and
returning a subset of the candidate results as a function of the confidence scores.

12. A computer-implemented method for identity intelligence, the method comprising:
receiving, from a user and using at least one processor, image data wherein the image data comprises an image of a face;
receiving, using the at least one processor, a user authentication datum;
extracting, using the at least one processor, a plurality of facial features from the image data;
performing, using the at least one processor, a reverse facial lookup, wherein performing the reverse facial lookup comprises:
inputting the plurality of facial features; and
receiving, in response to the plurality of facial features, a subset of the candidate results;
performing, using the at least one processor, an image analysis, wherein the image analysis comprises:
inputting the plurality of facial features into an image analysis model;
receiving as output from the image analysis model, a set of estimated demographic characteristics and an artificial generation likelihood score;
aggregating, using the at least one processor, the subset of candidate results and the set of estimated demographic characteristics into a results dataset, wherein aggregating the subset of candidate results and the set of estimated demographic characteristics into the results dataset comprises:
aggregating the subset of candidate results and the set of estimated demographic characteristics into a common data structure;
filtering the results dataset to remove low-confidence data and outliers; and
clustering the results dataset into one or more profiles using a clustering algorithm; and
outputting, using the at least one processor, the results dataset to the user.

13. The method of claim 12, further comprising preforming, using the at least one processor, an advanced search, wherein performing the advanced search comprises determining whether the advanced search has been requested using the user authentication datum and, if the advanced search has been requested:
normalizing the one or more profiles; and
retrieving query result data by querying a plurality of advanced search application programming interfaces (APIs) using the normalized one or more profiles.

14. The method of claim 13, wherein performing the advanced search further comprises integrating the query result data into the results dataset.

15. The method of claim 12, wherein returning the subset of the candidate results as a function of the confidence scores comprises receiving uniform resource locators (URLs) associated with the candidate results.

16. The method of claim 15, wherein performing the reverse facial lookup further comprises:
retrieving scraped data associated with the URLs using a web scraper; and
cleaning the scraped data using a dataset cleaner script, wherein the dataset cleaner script is configured to:
normalize the scraped data associated with each of the URLs into a consistent internal representation;
normalize raw text content of the scraped data; and
populate structured candidate fields associated with each of the URLs with ranked lists of likely values for key profile attributes.

17. The method of claim 16, wherein performing the reverse facial lookup further comprises:
inputting each set of cleaned scraped data into a large language model (LLM); and
generating, using the LLM, structured profile attributes associated with a subject.

18. The method of claim 17, wherein the LLM comprises an instruction-tuned transformer model, wherein:
each inputted set of cleaned scraped data is provided to the LLM as a structured JavaScript Object Notation (JSON) file; and
the instruction-tuned transformer model is constrained to produce strictly formatted JSON outputs with predefined fields.

19. The method of claim 12, further comprising performing, using the at least one processor, a reverse name search, wherein the reverse name search comprises:
normalizing name data;
constructing a plurality of API queries using the name data; and
retrieving records associated with the name data using the plurality of API queries and a plurality of APIs.

20. The method of claim 19, further comprising:
determining, using the at least one processor, whether name data has been received from the user;
conduct the reverse name search if the name data has been received; and
skip the reverse name search if the name data has not been received.

21. The method of claim 12, further comprising:
monitoring, using the at least one processor, compute availability using a compute monitor; and
dispatching, using the at least one processor, the image data for image processing as a function of determining, by the compute monitor, that there is compute availability.

22. The method of claim 12, wherein performing the reverse facial lookup further comprises:
comparing the plurality of facial features to a plurality of candidate results;
determining confidence scores as a function of comparing the plurality of facial features to the plurality of candidate results; and
returning a subset of the candidate results as a function of the confidence scores.
